(19) United States
(12) Patent Application Publication
(10) Pub. No.: US 2026/0089544 A1
(43) Pub. Date: Mar. 26, 2026

(54) DEVICES AND METHODS FOR MANAGING QUALITY OF SERVICE FLOWS MIGRATION AMONG PDU SESSIONS OF THE SAME UE

(71) Applicant: HUAWEI TECHNOLOGIES CO., LTD., Shenzhen (CN)

(72) Inventors: Clarissa Marquezan, Munich (DE); Riccardo Trivisonno, Munich (DE); Susanna Schwarzmann, Munich (DE)

(73) Assignee: HUAWEI TECHNOLOGIES CO., LTD., Shenzhen (CN)

(21) Appl. No.: 19/404,926

(22) Filed: Dec. 1, 2025

Related U.S. Application Data
(63) Continuation of application No. PCT/EP2023/064672, filed on Jun. 1, 2023.

(51) Int. Cl. H04W 28/02; H04L 45/24; H04W 76/22; H04W 88/06

(52) U.S. Cl. CPC H04W 28/0215; H04L 45/24; H04W 28/0205; H04W 28/0268; H04W 76/22; H04W 88/06

(57) ABSTRACT

Methods and apparatus are provided for managing data traffic transmission of a plurality of traffic flows associated with a pair of PDU sessions, which relate to communications networks. A UE is connectable with a first AN using a first PDU session, and connectable with a second AN using a second PDU session, simultaneously. The first and the second ANs are of the same RAN type. A first CPF is disclosed to obtain first indication information indicative of whether data transmission of the UE supports flow migration capability. The flow migration capability indicates a capability of switching the data traffic transmission between redundant transmission and parallel transmission. If supported, the first CPF determines flow migration information that comprises mapping information among traffic flows of the first PDU session and the second PDU session and provides the flow migration information to the UE and/or related UPF.

### CROSS-REFERENCE TO RELATED APPLICATIONS

This application is a continuation of International Application No. PCT/EP2023/064672, filed on Jun. 1, 2023, the disclosure of which is hereby incorporated by reference in its entirety.

### TECHNICAL FIELD

Embodiments of the present disclosure generally relate to wireless communications. For instance, embodiments of the present disclosure relate to devices and methods for managing quality-of-service (QoS) flows migration among PDU sessions of the same user equipment. Embodiments of the present disclosure provide a control plane entity for managing one or more traffic flows of a user equipment (UE), also provide a UE manageable by the control plane entity, and further provide corresponding methods and computer programs.

### BACKGROUND

The 3rd generation partnership project (3GPP) SA1 TR 22.856 Release 19 defines use cases of metaverse applications, which constitutes a type of application that demand high reliability, very low latency and high bandwidth. In mobile networks, this type of application is associated with Real Time Broadband Communication (RTBC) type of traffic.

The use of extended reality (XR) and metaverse may be used for medical procedures and is becoming increasingly relevant. For instance, 3GPP SA1 TR 22.856 Release 19 defines the use case on metaverse for critical health care services (FS_METAVERSE TR 22.856Clause 5.10). In this use case, a physician can perform an operation remotely supported by an XR Application, and the physician may use a UE to connect to an operation theatre via a mobile network. In this kind of XR application, it is proposed to use 5G mechanisms for Ultra Reliable Low Latency Communication (URLLC) such as using Dual Connectivity (DC) with redundancy as defined in TR 23.501. Such a mechanism defines that two PDU sessions are established using different RAN Nodes and UPFs, and the two PDU sessions are paired. A paired PDU session may have the following conventional features:
there are two QoS flows configured with the same or similar QoS requirements in each respective PDU session for enabling the transmission of the XR application data
data packets related to the XR application are duplicated at the UE transmitted from UE to Application (i.e., uplink), and are duplicated at the UPF and transmitted from the UPF to UE (i.e., downlink)
one stream of data packets is inserted in a first paired PDU Session (e.g., in an appropriate QOS Flow)
another stream of duplicated data packets is inserted in a second paired PDU session (e.g., in another appropriate QoS Flow)

In this case, there are two disjoint path between the UE (at the operation theatre) and the XR application (at the data network). The data traffic of the XR application (e.g., a flow requiring 5 Mbps bit rate) is duplicated and transmitted via the two disjoint paths. In this case, although the actual data traffic required by the application is a flow of 5 Mbps, the mobile operator uses effectively 10 Mbps (5 Mbps in each path established in the paired PDU sessions) to provide the connectivity for the application with high reliability.

### SUMMARY

Consider an exemplary scenario where redundant transmission with dual connectivity for supporting metaverse is used for data transmission of critical healthcare services. This means that two PDU sessions are paired, each configured with the same QoS parameters for handling data traffic. Packets related to such applications are duplicated. For instance, assume a scenario where each of the paired PDU sessions uses 5 Mbps with GBR data traffic. During an operation, if a problem happens on the patient's side, e.g., an artery of the patient breaks and the whole image of what is happening on the patient's side needs to be transferred to the application. This means in terms of a network that the UE data traffic may suddenly change from 5 Mbps to 10 Mpbs. This leads to a QoS requirement change in the effective data traffic, i.e., the amount of data—not duplicated data—that needs to be transferred. As a consequence, for keeping the same reliability, the network would need 20 Mpbs for handling the surge in the data traffic for the application.

In order to handle a sudden surge of data traffic in a redundant transmission with dual connectivity, the following conventional approaches may be used:
using triggers to handle the surge of traffic: a) either the involved UE or a RAN node or a control plane entity of the core network may trigger a PDU session modification; b) if the involved RAN node in the scenario is not able to increase the resources from 5 Mbps to 10 Mbps, it can trigger a PDU session release at the core network (e.g., to allow a new capable PDU session to be established);
upon receiving the triggers, the core network side may perform the following actions: a) The CN can try to perform the PDU session modification at both paired PDU sessions to define new GBR QOS requirements (e.g., 10 Mbps) at both paired PDU sessions. However, this is still subjected to the RAN nodes. Any RAN node related to the paired PDU sessions not having the useful resources to support the new GBR QoS requirements may reject the PDU session modification. b) The CN can release any PDU session at a RAN node not fulfilling the new GBR QOS requirements.

When the core network tries to enforce these changes, critical data traffic of XR application may be dropped at the RAN side due to high control plane delay in reconfiguration of the PDU sessions. The reliability of XR application can be reduced by half or more, if one of the PDU sessions is released and the other PDU session cannot be served with the required QoS requirement associated with the surge in traffic of the XR application. This leads to that the Metaverse application cannot be updated timely with the required data. In this case, the physician cannot timely react to issues happening on the patient's side.

Moreover, handling sudden traffic surge may also lead to low network scalability in regions serving critical health XR applications. Because a mobile network may reserve resources for certain regions of the network to be able to dynamically increase the QoS resources to the paired PDU sessions in case of surge in traffic. This reduces the scalability of the network to support more users simultaneously. Penalties may also occur that may be borne by the mobile operator for violating reliability requirements of critical health XR applications, e.g., for not guaranteeing the agreed reliability level by releasing paired PDU sessions.

In view of the above, embodiments are provided to effectively handle traffic surge in XR applications using redundant transmission with dual connectivity, to avoid overprovisioning a QoS flow with the maximum possible bitrate expected, and to avoid causing permanent degradation of reliability requirements in the paired PDU sessions associated with the XR application.

A first aspect of this disclosure provides a first control plane entity for managing data (traffic) transmission of a plurality of traffic flows of UE. The plurality of traffic flows of the UE are associated with a pair of PDU sessions of the UE. A first PDU session of the pair of PDU sessions is connectable to a data network using a first access network; a second PDU session of the pair of PDU sessions is connectable to the data network using a second access network. The first access network and the second access network are of the same type of radio access technology.

The first control plane entity is configured to obtain first indication information. The first indication information is indicative of whether one or more of the UE, the plurality of traffic flows, the first PDU session, the second PDU session, the pair of PDU sessions, and an application support flow migration capability. The flow migration capability indicates a capability of switching the data traffic transmission between redundant transmission and parallel transmission.

For redundant transmission, data packets related to one or more first traffic flows from the plurality of traffic flows are duplicated in one or more second traffic flows from the plurality of flows. The one or more first traffic flows are related to the first PDU session, and the one or more second traffic flows are related to the second PDU session.

For parallel transmission, the data packets related to the one or more first traffic flows (or data packets related to the data transmission) are transmitted either:
in both of the first and second traffic flows, in which the data packets exceeding the capacity of the one or more first traffic flows are transmitted in the one or more second traffic flows, or
only in the one or more second traffic flows, in which all data packets related to the one or more first traffic flows are transmitted in the one or more second traffic flows.

The first control plane entity is further configured to:
determine that one or more of the UE, the plurality traffic flows, the first PDU session, the second PDU session, the pair of PDU sessions, and the application support flow migration capability based on the first indication information;
determine flow migration information for the first PDU session and the second PDU session, in which the flow migration information comprises mapping information among the one or more first traffic flows of the first PDU session and the one or more second traffic flows of the second PDU session; and
provide the flow migration information to one or more of the UE and a user plane entity.

Optionally, the first control plane entity may be referred to as a QoS Flow Migration (QFM) manager. The first indication information may be referred to as a QFM capability indication or QFM capable indication. The flow migration information may be referred to as QFM information.

According to this disclosure, the shortage of resources because of the sudden extra capacity required by the XR application can be alleviated, while the network can activate further mechanisms to change configurations for UEs at the affected region. The sudden package dropping of flows that could experience by XR UEs due to extra data capacity required for transmission can be reduced, since the two paired paths can be used and coordinated according to flow migration information in an effective way.

In this way, the stability and robustness of the network can be improved, e.g., for various traffic conditions. QoS for delivering application data can be ensured.

In an implementation form of the first aspect, the first control plane entity may be further configured to:
provide first switch information to one or more of the user plane entity and the UE, wherein the first switch information comprises information to enable the parallel transmission between the one or more first traffic flows and the one or more second traffic flows.

In a further implementation form of the first aspect, the first control plane entity may be further configured to:
provide second switch information to one or more of the user plane entity and the UE, wherein the second switch information comprises information to enable the redundant transmission between the one or more first traffic flows and the one or more second traffic flows.

In a further implementation form of the first aspect, the first indication information may comprise one or more of the following:
a flow migration subscription indication;
a flow migration application function indication;
a flow migration policy indication;

In a further implementation form of the first aspect, the flow migration subscription indication is obtained from a further entity storing subscription information and the flow migration subscription indication, and the flow migration subscription indication is indicative of allowing or restricting the flow migration capability for one or more of the following information:
UE identification;
application information;
data network information;
network slice information;
PLMN (public land mobile network) identification;
PDU session identification;
PDU session pair identification;
flow description; and
flow identification.

In a further implementation form of the first aspect, the flow migration application function indication is obtained from an application function entity, and the flow migration application function indication is indicative of allowing or restricting the flow migration capability for one or more of the following information:
UE identification;
application information;
data network information;
PDU session identification;
PDU session pair identification;
transaction reference ID;
application session context identification;
application session identification;
flow description; and
network slice information.

In a further implementation form of the first aspect, the flow migration policy indication is obtained from a second control plane entity or is configured at the first control plane entity, and the flow migration policy indication is indicative of allowing or restricting the flow migration capability for one or more of the following information:
UE identification;
application information;
data network information; and
network slice information.

In a further implementation form of the first aspect, the first control plane entity may be further configured to obtain flow migration condition information, wherein the flow migration condition information comprises monitoring information for activating or deactivation the flow migration capability.

The flow migration condition information may be referred to as QFM Conditions.

In a further implementation form of the first aspect, the flow migration condition information is obtained based on one or more of the following:
together with the flow migration subscription indication;
together with the flow migration application function indication;
together with the flow migration policy indication;
is configured at the first control plane entity; and
is comprised in the flow migration information.

In a further implementation form of the first aspect, the flow migration condition information comprises one or more of:
an upper threshold of a QoS-related measurement to activate the flow migration capability;

a lower threshold of a QoS-related measurement to deactivate the flow migration capability;
a maximum interval of time for keeping the flow migration capability activated;
a minimum interval of time for keeping the flow migration capability activated;
a threshold to deactivate the flow migration capability; and
a degradation threshold to deactivate the flow migration capability

In a further implementation form of the first aspect, the first control plane entity may be further configured to obtain a flow migration trigger indication, wherein the flow migration trigger indication is a flag that indicates to the first control plane entity that the establishment of the first PDU session and/or the second PDU session requires the flow migration capability.

In a further implementation form of the first aspect, the first control plane entity may be further configured to obtain the first indication information based on the flow migration trigger indication.

In a further implementation form of the first aspect, the mapping information comprises information related to mapping the one or more first traffic flows associated with the first PDU session to the one or more second flows associated with the second PDU session, wherein the first PDU session and the second PDU session are associated with a same PDU session pair ID.

In a further implementation form of the first aspect, the mapping information further comprises one or more of the following:
tunnel mapping information for mapping a core network tunnel and/or a radio access network tunnel of the one or more first traffic flow associated with the first PDU session to one or more further core network tunnels and/or one or more further radio access network tunnels of the one or more second traffic flows associated with the second PDU session; and
a type of data traffic migration, wherein the type of data traffic migration defines the mapping of data traffic being migrated from the one or more first traffic flows into the one or more second traffic flows.

In a further implementation form of the first aspect, the type of data traffic migration is indicative of one of the following types:
rerouting all data transmission from the one or more first traffic flows to the one or more second traffic flows,
rerouting data transmission exceeding a certain bit rate from the one or more first traffic flows to the one or more second traffic flows, and
rerouting a certain percentage of data transmission from the one or more first traffic flows to the one or more second traffic flows.

For instance, any one of the following is possible:
reroute or move all data transmission to a single flow, which denotes to move all data transmission of the first flow of the first PDU session to one second flow of the second PDU session
split all data transmission into multipe flows, which denotes to move all data transmission of the first flow of the first PDU session to at least two second flows of the second PDU session
reroute data transmission exceeding bit rate to a single flow, which denotes to move data exceeding the bitrate capacity of the first flow of the first PDU session to one second flow of the second PDU session
split data transmission exceeding bit rate to multiple flows, which denotes to move data exceeding the bitrate capacity of the first flow of the first PDU session to at least two second flows of the second PDU session
reroute or move a percentage of data transmission to a single flow, which denotes to move a percentage of data transmission of the first flow of the first PDU session to one second flow of the second PDU session
split a percentage of data transmission to a single flow, which denotes to move a percentage of data transmission of the first flow of the first PDU session to at least two second flows of the second PDU session

In a further implementation form of the first aspect, the first control plane entity may be further configured to send a notification to the application function entity, wherein the notification is indicative of one or more of the following:
the flow migration capability is allowed;
the flow migration capability is restricted;
the flow migration capability is activated; and
the flow migration capability is deactivated.

The aforementioned notification to the application function may also be referred as the indication of QFM status (or QFM status indication).

In a further implementation form of the first aspect, the first control plane entity may be further configured to obtain one or more of:
a network first switch indication from the user plane function and/or from the UE, wherein the network first switch indication is indicative of a need or a request for activating the flow migration capability;
an application first switch indication from an application function entity, wherein the application first switch indication is indicative of a need or a request for activating the flow migration capability.

In a further implementation form of the first aspect, the first control plane entity may be further configured to determine the first switch information based on the network first switch indication, or the application first switch indication, or an internal configuration related to the first switch information, or a combination thereof.

In a further implementation form of the first aspect, the network first switch indication comprises one or more of the following:
UE identification;
PDU session pair identification;
first PDU session identification and/or second PDU session identification;
network candidate first switch information and/or network candidate second switch information, wherein the network candidate first switch information and/or network candidate second switch information are determined by the UP entity and/or the UE, the network candidate first switch information comprises the first switch information, and the network candidate second switch information comprises the second switch information.

In a further implementation form of the first aspect, the application first switch indication comprises one or more of:
a transaction reference ID;
a flag indicating a request for activation of the flow migration capability switching from redundant to parallel transmission of the paired PDU sessions;
application information;
data network information;
UE information;
a flow description;
an identification of the application session context;
a PDU session pair ID;
a PDU session ID;
network slices information;
application candidate first switch information and/or application candidate second switch information, wherein the application candidate first switch information and/or application candidate second switch information are determined by the application function entity, the application candidate first switch information comprises the first switch information, and the application candidate second switch information comprises the second switch information.

In a further implementation form of the first aspect, the first switch information comprises one or more of the following:
an indication to switch to the parallel transmission;
information on the first PDU session and/or the second PDU session;
information on the first flow and/or the second flow;
information on the PDU session pair;
a type of data traffic migration; and
modified flow migration information, wherein the modified flow migration information denotes a change in a previously defined flow migration information for the PDU session pair to enable a switch to the parallel transmission.

In a further implementation form of the first aspect, the first switch information further comprises one or more of the following information:
a confirmation of acceptance of the network candidate first switch information received from the user plane entity and/or UE;
a confirmation of acceptance of the application candidate first switch information received from the application function;
an indication of modification of the network candidate first switch information received from the user plane entity and/or the UE;
an indication of modification of the application candidate first switch information received from the application function entity;
an indication of rejection of the network candidate first switch information received from the user plane entity and/or the UE, wherein the indication of rejection of the network candidate first switch information denotes that the received network candidate first switch information cannot be applied; and
an indication of rejection of the application candidate first switch information received from the application function entity, wherein the indication of rejection of the application candidate first switch information denotes that the received application candidate first switch information cannot be applied.

In a further implementation form of the first aspect, the first switch information further comprises a temporal indication for activating the flow migration capability.

In a further implementation form of the first aspect, the first control plane entity may be further configured to send a notification to the application function entity. The notification indicates one of the following:
a confirmation of acceptance of the application candidate first switch information received from the application function entity;
an indication of modification of the application candidate first switch information received from the application function entity; and
an indication of rejection of the application candidate first switch information received from the application function entity.

The aforementioned notification to the application function may also be referred as the indication of QFM status (or QFM status indication).

In a further implementation form of the first aspect, the first control plane entity may be further configured to obtain one or more of:
a network second switch indication from the user plane function and/or from the UE, wherein the network second switch indication indicates a need or a request for deactivating the flow migration capability;
an application second switch indication from an application function, wherein the application second switch indication indicates a need or a request for deactivating of the flow migration capability.

In a further implementation form of the first aspect, the first control plane entity may be further configured to determine the second switch information based on the network second switch indication, or the application second switch indication, or an internal configuration related to second switch information or a combination thereof.

In a further implementation form of the first aspect, the second switch information comprises one or more of the following information:
an indication to switch to the redundant transmission;
information on the first PDU session and/or the second PDU session;
information on the first flow and/or the second flow;
information on the PDU session pair;
an original flow migration information, wherein the original flow migration information denotes a previously defined flow migration information for the PDU session pair before switching to the parallel transmission; and
an indication to use an original flow migration, wherein the indication to use the original flow migration comprises a flag indicating a previously defined flow migration information to be restored for the PDU session pair before switching to the parallel transmission.

In a further implementation form of the first aspect, the first control plane entity may be further configured to provide the flow migration condition information to one or more of the user plane entity and the UE, such that the one or more of the user plane entity and the UE trigger the network first switch indication and/or the network second switch indication based on the received flow migration condition information.

In a further implementation form of the first aspect, the first control plane entity may be further configured to monitor the flow migration condition information for determining whether to provide the first switch information and/or the second switch information to one or more of the user plane entity and UE.

A second aspect of this disclosure provides a user plane flow migration entity associated with data transmission of a plurality of traffic flows of UE. The plurality of traffic flows of the UE are associated with a pair of PDU sessions of the UE. A first PDU session of the pair of PDU sessions is connectable to a data network using a first access network; a second PDU session of the pair of PDU sessions is connectable to the data network using a second access network. The first access network and the second access network are of the same type of radio access technology. The user plane flow migration entity is configured to:
receive flow migration information for the first PDU session and the second PDU session from a first control plane entity, wherein the flow migration information comprises mapping information among one or more first traffic flows of the first PDU session and one or more second traffic flows of the second PDU session; and
configure the first PDU session and the second PDU session to support flow migration capability based on the flow migration information.

The flow migration capability indicates a capability of switching the data traffic transmission between redundant transmission and parallel transmission.

For redundant transmission, data packets related to one or more first traffic flows from the plurality of traffic flows are duplicated in one or more second traffic flows from the plurality of flows, in which the one or more first traffic flows are related to the first PDU session, and the one or more second traffic flows are related to the second PDU session.

For parallel transmission, the data packets related to the one or more first traffic flows (or data packets related to the data transmission) are transmitted either:
in both of the first and second traffic flows, wherein the data packets exceeding the capacity of the one or more first traffic flows are transmitted in the one or more second traffic flows, or
only in the one or more second traffic flows, wherein all data packets related to the one or more first traffic flows are transmitted in the one or more second traffic flows.

According to this disclosure, the shortage of resources because of the sudden extra capacity required by the XR application can be alleviated, while the network can activate further mechanisms to change configurations for UEs at the affected region. The sudden package dropping of flows that could experience by XR UEs due to extra data capacity can be reduced, since two paired paths (e.g., paired PDU sessions) can be used and coordinated according to flow migration information in an effective way.

In this way, the stability and robustness of the network can be improved, e.g., for various traffic conditions. QoS for delivering application data can be ensured.

In an implementation form of the second aspect, the user plane flow migration entity may be further configured to obtain first switch information from the first control plane entity, wherein the first switch information comprises information to enable the parallel transmission between one or more first traffic flows associated with the first PDU session and the one or more second traffic flows associated with the second PDU session.

In a further implementation form of the second aspect, the user plane flow migration entity may be further configured to:
obtain second switch information from the first control plane entity, wherein the second switch information comprises information to enable the redundant transmission between the one or more first traffic flows associated with the first PDU session and the one or more second traffic flows associated with the second PDU session.

In a further implementation form of the second aspect, the user plane flow migration entity may be at least a part of the UE or a user plane entity.

In a further implementation form of the second aspect, the user plane flow migration entity is at least a part of the UE and is further configured to provide to the first control plane entity a flow migration trigger indication, wherein the flow migration trigger indication is a flag that indicates to the first control plane entity that the establishment of the first PDU session and/or the second PDU session requires the flow migration capability.

In a further implementation form of the second aspect, the user plane flow migration entity may be further configured to provide to the first control plane entity with one of the following:
a network first switch indication, wherein the network first switch indication is indicative of a need or a request for activating the flow migration capability;
a network second switch indication, wherein the network first switch indication is indicative of a need or a request for activating the flow migration capability.

In a further implementation form of the second aspect, the user plane flow migration entity may be further configured to:
receive from the first control plane entity flow migration condition information, wherein the flow migration condition information comprises monitoring information for activating or deactivating the flow migration capability,
send the network first switch indication and/or the network second switch indication based on the received flow migration condition information.

A third aspect of this disclosure provides an application function (AF) entity associated with data traffic transmission of a plurality of traffic flows of UE. The plurality of traffic flows of the UE are associated with a pair of PDU sessions of the UE. A first PDU session of the pair of PDU sessions is connectable to a data network using a first access network; a second PDU session of the pair of PDU sessions is connectable to the data network using a second access network. The first access network and the second access network are of the same type of radio access technology. The AF entity is configured to obtain, from a first control plane entity, a notification comprising at least one indication of:
a flow migration capability is allowed,
the flow migration capability is restricted,
the flow migration capability is activated; and
the flow migration capability is deactivated.

The flow migration capability indicates a capability of switching the data traffic transmission between redundant transmission and parallel transmission.

For redundant transmission, data packets related to one or more first traffic flows from the plurality of traffic flows are duplicated in one or more second traffic flows from the plurality of flows, in which the one or more first traffic flows are related to the first PDU session, and the one or more second traffic flows are related to the second PDU session.

For parallel transmission, the data packets related to the one or more first traffic flows are transmitted either:
in both of the first and second traffic flows, wherein the data packets exceeding the capacity of the one or more first traffic flows are transmitted in the one or more second traffic flows, or
only in the one or more second traffic flows, wherein all data packets related to the one or more first traffic flows are transmitted in the one or more second traffic flows.

According to this disclosure, the shortage of resources because of the sudden extra capacity required by the XR application can be alleviated, while the network can activate further mechanisms to change configurations for UEs at the affected region. The sudden package dropping of flows that could experience by XR UEs due to extra data capacity can be reduced, since two paired paths (e.g., paired PDU sessions) can be used and coordinated according to flow migration information in an effective way.

In this way, the stability and robustness of the network can be improved, e.g., for various traffic conditions. QoS for delivering application data can be ensured.

In an implementation form of the third aspect, the AF entity may be further configured to provide to the first control plane entity a flow migration application function indication, wherein the flow migration application function indication is indicative of allowing or restricting the flow migration capability for one or more of the following information:
UE identification;
application information;
data network information;
PDU session identification;
PDU session pair identification;
transaction reference ID;
application session context identification;
application session identification;
flow description; and
network slice information.

In a further implementation form of the third aspect, the AF entity may be further configured to provide to the first control plane entity one of the following:
an application first switch indication, wherein the application first switch indication indicates a need or a request for activating the flow migration capability
an application second switch indication, wherein the application second switch indication indicates a need or a request for deactivating the flow migration capability.

In a further implementation form of the third aspect, the application first switch indication comprises one or more of:
a transaction reference ID;
a flag indicating a request for activation of the flow migration capability switching from redundant to parallel transmission of the paired PDU sessions;
application information;
data network information;
UE information;
a flow description;
an identification of the application session context;
a PDU session pair ID;
a PDU session ID;
network slices information;
application candidate first switch information and/or application candidate second switch information, wherein the application candidate first switch information and/or application candidate second switch information are determined by the application function entity, the application candidate first switch information comprises the first switch information, and the application candidate second switch information comprises the second switch information.

In a further implementation form of the third aspect, the AF entity may be further configured to obtain a notification from the first control plane entity, wherein the notification indicates one of the following:
a confirmation of acceptance of the application candidate first switch information received from the application function entity;
an indication of modification of the application candidate first switch information received from the application function entity; and
an indication of rejection of the application candidate first switch information received from the application function entity.

In a further implementation form of the third aspect, the AF entity may be further configured to provide to the first control plane entity flow migration condition information, wherein the flow migration condition information comprises monitoring information for activating or deactivation the flow migration capability.

In a further implementation form of the third aspect, the flow migration condition information is provided by the AF entity to the first control plane entity together with the flow migration application function indication.

A fourth aspect of this disclosure provides a method for managing data traffic transmission of a plurality of traffic flows of UE. The plurality of traffic flows of the UE are associated with a pair of PDU sessions of the UE. A first PDU session of the pair of PDU sessions is connectable to a data network using a first access network; a second PDU session of the pair of PDU sessions is connectable to the data network using a second access network. The first access network and the second access network are of the same type of radio access technology. The method comprises the following steps:
obtaining, by a first control plane entity, first indication information, wherein the first indication information is indicative of whether one or more of the UE, the plurality of traffic flows, the first PDU session, the second PDU session, the pair of PDU sessions, and an application support flow migration capability;
determining, by the first control plane entity, that one or more of the UE, the plurality traffic flows, the first PDU session, the second PDU session, the pair of PDU sessions, and an application support flow migration capability supports flow migration capability based on the first indication information;
determining, by the first control plane entity, flow migration information for the first PDU session and the second PDU session, wherein the flow migration information comprises mapping information among one or more first traffic flows of the first PDU session and one or more second traffic flows of the second PDU session; and
providing, by the first control plane entity, the flow migration information to one or more of the UE and a user plane entity.

The flow migration capability indicates a capability of switching the data traffic transmission between redundant transmission and parallel transmission.

For redundant transmission, data packets related to one or more first traffic flows from the plurality of traffic flows are duplicated in one or more second traffic flows from the plurality of flows, in which the one or more first traffic flows are related to the first PDU session, and the one or more second traffic flows are related to the second PDU session.

For parallel transmission, the data packets related to the one or more first traffic flows are transmitted either:
in both of the first and second traffic flows, wherein the data packets exceeding the capacity of the one or more first traffic flows are transmitted in the one or more second traffic flows, or
only in the one or more second traffic flows, wherein all data packets related to the one or more first traffic flows are transmitted in the one or more second traffic flows.

The method of the fourth aspect may have implementation forms that correspond to the implementation forms of the first control plane entity of the first aspect. The method of the fourth aspect and its implementation forms achieve the same advantages as described for the first control plane entity of the first aspect and its respective implementation forms.

A fifth aspect of this disclosure provides a method for managing data traffic transmission of a plurality of traffic flows of UE. The plurality of traffic flows of the UE are associated with a pair of PDU sessions of the UE. A first PDU session of the pair of PDU sessions is connectable to a data network using a first access network; a second PDU session of the pair of PDU sessions is connectable to the data network using a second access network. The first access network and the second access network are of the same type of radio access technology. The method comprises the following steps:
receiving, by a user plane flow migration entity, flow migration information for the first PDU session and the second PDU session from a first control plane entity, wherein the flow migration information comprises mapping information among one or more first traffic flows of the first PDU session and one or more second traffic flows of the second PDU session; and
configuring, by the user plane flow migration entity, the first PDU session and the second PDU session to support flow migration capability based on the flow migration information.

The flow migration capability indicates a capability of switching the data traffic transmission between redundant transmission and parallel transmission.

For redundant transmission, data packets related to one or more first traffic flows from the plurality of traffic flows are duplicated in one or more second traffic flows from the plurality of flows, in which the one or more first traffic flows are related to the first PDU session, and the one or more second traffic flows are related to the second PDU session.

For parallel transmission, the data packets related to the one or more first traffic flows are transmitted either:
in both of the first and second traffic flows, wherein the data packets exceeding the capacity of the one or more first traffic flows are transmitted in the one or more second traffic flows, or
only in the one or more second traffic flows, wherein all data packets related to the one or more first traffic flows are transmitted in the one or more second traffic flows.

The method of the fifth aspect may have implementation forms that correspond to the implementation forms of the user plane flow migration entity of the second aspect. The method of the fifth aspect and its implementation forms achieve the same advantages as described for the user plane flow migration entity of the second aspect and its respective implementation forms.

A sixth aspect of this disclosure provides a method for managing data traffic transmission of a plurality of traffic flows of UE. The plurality of traffic flows of the UE are associated with a pair of PDU sessions of the UE. A first PDU session of the pair of PDU sessions is connectable to a data network using a first access network; a second PDU session of the pair of PDU sessions is connectable to the data network using a second access network. The first access network and the second access network are of the same type of radio access technology. The method comprises obtaining, by an application function entity, from a first control plane entity a notification comprising at least one indication of:
a flow migration capability is allowed, the flow migration capability is restricted,
the flow migration capability is activated; and
the flow migration capability is deactivated.

The flow migration capability indicates a capability of switching the data traffic transmission between redundant transmission and parallel transmission.

For redundant transmission, data packets related to one or more first traffic flows from the plurality of traffic flows are duplicated in one or more second traffic flows from the plurality of flows, in which the one or more first traffic flows are related to the first PDU session, and the one or more second traffic flows are related to the second PDU session.

For parallel transmission, the data packets related to the one or more first traffic flows are transmitted either:
in both of the first and second traffic flows, wherein the data packets exceeding the capacity of the one or more first traffic flows are transmitted in the one or more second traffic flows, or
only in the one or more second traffic flows, wherein all data packets related to the one or more first traffic flows are transmitted in the one or more second traffic flows.

The method of the sixth aspect may have implementation forms that correspond to the implementation forms of the application function entity of the third aspect. The method of the sixth aspect and its implementation forms achieve the same advantages as described for the application function entity of the third aspect and its respective implementation forms.

A seventh aspect of this disclosure provides a system comprising one or more of the first control plane entity according to the first aspect, the user plane user plane flow migration entity according to the second aspect, and the application function entity according to the third aspect or any implementation form thereof.

An eighth aspect of this disclosure provides a computer program comprising instructions which, when the program is executed by a computer, cause the computer to perform the method of the fourth aspect, the fifth aspect, the sixth aspect, or any implementation form thereof.

A ninth aspect of this disclosure provides a non-transitory storage medium storing executable program code which, when executed by a processor, causes the method according to the fourth aspect, the fifth aspect, the sixth aspect, or any implementation form thereof to be performed.

A tenth aspect of this disclosure provides a chipset configured to perform the method according to the fourth aspect, the fifth aspect, the sixth aspect, or any implementation form thereof.

The following features are particularly described in this disclosure, for the example of a QFM manager as a control plane entity and a UE manageable by the QFM manager, with the following features.
Feature 1 (Bind QoS Flows for migration mechanism between paired PDU Sessions):
   the QoS flow manager identifies whether a PDU session, UE, or QFI can operate with QoS flow migration (QFM) capability; and
   the QoS flow manager delivers QFM Policy to a UE, which is optional.
Feature 2 (Provision QoS Flow migration information to entities of the network):
   the QoS flow manager configures, for each paired PDU sessions, the QFM information (e.g., native and visiting QoS flow information); and
   the QoS flow manager configures a UE and/or UPF with QFM information.
Feature 3 (Triggering and enforcing the start and stop of QoS flow migration):
   The QoS flow manager activates or deactivates a QFI (or exceeding traffic of a QFI) migration among paired PDU sessions based on QFM information; and
   the QoS flow manager notifies an application function entity about the activation or deactivation of QFM capability.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of embodiments, a functionality or step to be performed by external entities is not reflected in the description of a detailed element of that entity which performs that step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms will be explained in the following description of embodiments in relation to the enclosed drawings, in which

FIG. 1 shows a schematic of a system according to this disclosure;

FIG. 2 shows an example of a system according to this disclosure;

FIG. 3 shows an example of steps performed by a QFM manager according to this disclosure;

FIG. 4 shows an example of interactions among entities;

FIG. 5 shows examples of obtaining QFM information;

FIG. 6 shows an example of QFM information provisioning;

FIG. 7 shows an example of signaling of QFM manager-triggered QFM capability and AF-triggered QFM capability;

FIG. 8 shows an example of signaling of SM Entity Triggered QFM Capability;

FIG. 9 shows an example of the activation of QFM capability for exceeding traffic of a flow in a paired PDU session;

FIGS. 10A-B show examples of system architectures according to this disclosure;

FIG. 11 shows an application scenario of this disclosure;

FIG. 12 shows a method according to this disclosure;

FIG. 13 shows a further method according to this disclosure;

FIG. 14 shows a further method according to this disclosure.

### EXPLANATION OF TERMS USED IN THIS DISCLOSURE

QFI flow or QoS flow: an abstraction to associate a data traffic to a certain QoS treatment. QFI defines also an identifier for the abstraction. In the present disclosure, terms of QFI, flow and QoS Flow are synonyms and are interchangeable.

QoS flow sessions or session: this term defines a logical association between a UE and a data network where one or more QoS flows of such UE are grouped and/or managed.

Interact: this term denotes a capability of an entity to provide and/or obtain information from another entity.

XR application refers to a type of application such as multi-modality application, multi-modality QoS flows, and multi-modality PDU sessions.

QoS requirements (or QoS characteristics) define one or more parameters related to the QoS to be associated with a data traffic. Examples of QoS requirements or characteristics are listed in 3GPP TS 23.501 Clause 5.7, such as: 5G QOS Identifier (5QI), Allocation and Retention Priority (ARP), Guaranteed Flow Bit Rate (GFBR), Maximum Flow Bit Rate (MFBR), GBR QOS Flow, Non-GBR QOS Flow, Packet Loss Rate, Packet Delay Budget (PDB), Averaging window, and Maximum Data Burst Volume (MDBV).

Redundant (or duplicated) transmission in the paired PDU sessions refers to data transmission using one of the paired PDU sessions for the transmission of duplicated data packets of another one of the paired PDU sessions. This means that the same content of a data packet is being transmitted over the two different PDU sessions simultaneously (note: not in the sense of rigorous clock synchronization, but in the sense that the same data packets are inserted in both of the paired PDU sessions at the same time).

Parallel (or simultaneous) transmission in the paired PDU sessions refers to data transmission using both of the paired PDU sessions for data packets without duplication. This means that different contents are enclosed in the different data packets that are being transmitted over the two PDU sessions simultaneously (note: not in the sense of rigorous clock synchronization, but in the sense that different data packets are inserted in the paired PDU sessions at the same time if both of the paired PDU sessions are used)

QFM capability indicates the possibility of changing (or switching) between redundant transmission and simultaneous transmission in the paired PDU sessions. That is, a capability of changing data transmission using one of the paired PDU sessions for the duplicated data packets (e.g., duplicated or redundant usage of the paired PDU sessions for the data traffic, a.k.a. duplicated or redundant transmission) into data transmission using both of the paired PDU sessions for data packets without duplication (e.g., parallel or simultaneous usage of the paired PDU sessions for data packets without duplication, a.k.a, parallel or simultaneous transmission), and vice-versa.

QFM capable (or capability) indication refers to information that determines that a UE, a PDU session, a PDU session pair, a QoS flow, and/or an application support (e.g., has the possibility, or is able to be configured) with QFM capability.

QFM information refers to information related to mapping (or linking, or binding, or association of) of core network tunnel information and/or the radio access network tunnel information from one PDU session to another PDU session, wherein the two PDU sessions share a same PDU session pair ID, such that one of the two PDU sessions can be used for redundant transmission (e.g., transmission of duplicated data traffic of the UE).

Native QFI flow/QOS flow relates to a QFI flow or a QoS flow of a PDU session whose parameters have been requested and/or established for the PDU session.

Visiting QFI flow/QOS flow relates to a QFI flow/QoS flow of a PDU session that identifies one or more parameters mapping the QFI flow/QoS flow from a different PDU session (e. g, a flow that is requested and/or established in another PDU session) to a native QFI flow/QoS flow from a PDU session where such mapping is defined.

QOS Flow Migration (QFM) information: information defining a mapping between a flow in one PDU session to another flow in another PDU session, where the two PDU sessions are paired to each other, and the pairing of the PDU sessions denotes the usage of the PDU sessions for redundant transmission in the paired PDU sessions. This information may further comprise definitions about the mapping of the QoS requirements for mapping among the two flows of the paired PDU sessions.

QFM capability: information denoting whether a UE, a PDU session, a pair of PDU sessions, an application, a flow descriptors (or flow descriptions), and/or a flow is (are) allowed to support (or capable of supporting) the activation of QoS flow migration mechanisms. Such mechanisms are related to one or more actions that can be taken in a mobile network to perform any one of the following:
a) stopping packet duplication for a given QoS flow in one of the paired PDU sessions, and use the capacity reserved for the stopped QoS flow for the data transmission of data packets from a QoS Flow from another one of the paired PDU sessions;
b) stopping QoS migration by removing traffic mapping from one QoS flow of one PDU session to another QoS flow of another PDU session, and restarting (or restoring) the transmission of data packets associated with one QoS Flow in one PDU session and the transmission of a duplication of the data packets in another QoS flow of another PDU session.

Indication for the activation (or deactivation) of QFM capability: information that triggers the QFM manager to evaluate and/or determine the QFM activation Information.

QFM activation information: information that defines the changes in the usage of the resources (e.g., a flow or QoS flow) of paired PDU sessions to switch from duplicated to parallel usage of such resources.

QFM deactivation information: information that defines the changes in the usage of the resources (e.g., a flow or QoS flow) of paired PDU sessions to switch from parallel to duplicated usage of such resources.

Indication of QFM status defines, for any one or more of a UE, a PDU session, a pair of PDU sessions, an application, a flow descriptor (or flow description), a flow related to an AF, whether a configuration of QFM capability has been enforced (or executed) or not; or defines whether activation or deactivation of QFM capability has been executed for switching between duplicated to parallel use of the paired PDU sessions for the data transmission (or vise-versa).

QFM subscription information determines or indicates whether the QFM capability is allowed and/or restricted for paired PDU sessions related to the QFM filter information.

QFM Filter information defines characteristics or parameters associated with PDU session information and/or a UE information.

QFM AF indication determines whether the QFM capability is allowed and/or restricted for paired PDU sessions related to the QFM AF Filters.

QFM AF filter defines characteristics or parameters associated with one or more of application information, UE information, and a flow description.

QFM policy indication provides information to determine whether the QFM capability is allowed and/or restricted for paired PDU sessions related to the QFM policy filters.

QFM Policy Filters defines the characteristics or parameters associated with one or more of application information, UE information, and a network-related information.

### DETAILED DESCRIPTION OF EMBODIMENTS

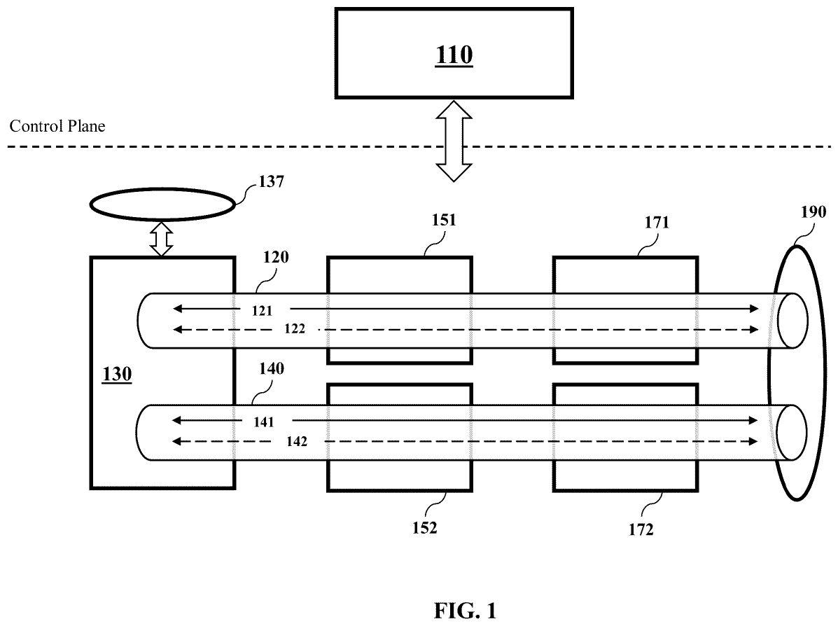

FIG. 1 shows a schematic of a system according to this disclosure. A first control plane (CP) entity 110 is disclosed for the system. The first CP entity 110 is configured to manage data (traffic) transmission of a plurality of traffic flows 121, 122, 141, 142 associated with UE 130. That data transmission of the plurality of traffic flows may be between a UE application 137 (application on the UE side) and a network application 190 (application on the network side). The plurality of traffic flows 121, 122, 141, 142 of the UE are associated with a pair of PDU sessions 120, 140 of the UE. A first PDU session 120 of the pair of PDU sessions is connectable to a data network using a first access network (AN) 151. A second PDU session 140 of the pair of PDU sessions is connectable to the data network using a second AN 152. The first AN 151 and the second AN 152 are of the same type of radio access technology. That is, the first AN 310 and the second AN 320 in the present disclosure are not based on different radio access technologies. For instance, the first AN 151 and the second AN 152 may be both 5G RAN or 6G RAN.

The first CP 110 (also referred to as a QFM manager 110) is configured to obtain first indication information. The first indication information (also referred to as QFM capability information in this disclosure) is indicative of whether one or more of the UE 130, the plurality of traffic flows 121, 122, 141, 142, the first PDU session 120, the second PDU session 140, the pair of PDU sessions, and an application support flow migration capability. Generally, the first indication information is indicative of whether flow migration capability is supported for the data traffic transmission. The flow migration capability is referred to as a capability of switching the data traffic transmission between redundant transmission (or duplicated transmission) and parallel transmission (or simultaneous transmission).

In redundant transmission, data packets related to one or more first traffic flows from the plurality of traffic flows are duplicated in one or more second traffic flows from the plurality of flows. The one or more first traffic flows are related to the first PDU session, and the one or more second traffic flows are related to the second PDU session 220.

In parallel transmission, the data packets of the data traffic transmission are transmitted:
in both of the first and second traffic flow, wherein the data packets exceeding the capacity of the one or more first traffic flows are transmitted in the one or more second traffic flows, or
only in the one or more second traffic flows, wherein all data packets related to the one or more first traffic flows are transmitted in the one or more second traffic flows.

In FIG. 1, two first traffic flows and two second traffic flows are depicted. However, it shall be understood that there is no limitation on the number of traffic flows comprised in each PDU session 120, 140. The number of the one or more first flows and the number of the one or more second flows may be the same or different.

The first CP entity 110 is further configured to determine that one or more of the UE 130, the plurality traffic flows 121, 122, 141, 142, the first PDU session 120, the second PDU session 140, the pair of PDU sessions, and the application support flow migration capability supports flow migration capability based on the first indication information. The first CP entity 110 is further configured to determine flow migration information (which may also be referred to as QFM information) for the first PDU session 120 and the second PDU session 140. The flow migration information comprises mapping information among the one or more first traffic flows 121, 122 of the first PDU session 120 and the one or more second traffic flows 141, 142 of the second PDU session 140. The first CP entity 110 is further configured to provide the flow migration information to one or more of the UE 130 and a user plane (UP) entity (also referred to as a user plane function (UPF) ) 171, 172. In FIG. 1, two UPFs are depicted. However, it shall be understood that there is no limitation on the number of the UPF(s). For instance, the first and the second AN 151, 152 may also be connectable to a common UPF (not shown in FIG. 1).

Based on the received flow migration information, the UE and/or the UPF are adapted to configure the first PDU session 120 and the second PDU session 140 to support flow migration capability based on the flow migration information.

In a possible case, the first CP entity 110 may be configured to provide first switch information to one or more of the UPF 171 and the UE 172. The first switch information comprises information to enable the parallel transmission between the one or more first traffic flows 121, 122 and the one or more second traffic flows 141, 142.

In a further possible case, the first CP entity 110 may be configured to provide second switch information to one or more of a UPF and the UE 130. The second switch information comprises information to enable the redundant transmission between the one or more first traffic flows and the one or more second traffic flows.

According to the present disclosure, the first CP entity is provided with the following features or capabilities:
F110: binding QoS Flows for migration mechanism between paired PDU sessions:
capable of identifying that PDU Sessions, UE or QFIs can operate with QFM capability,
capable of delivering QFM Policy to UE (optional depending on embodiments);
F120: provision of QoS flow migration information to entities of the network:
providing configuration for each paired PDU session the QFM information (e.g., native and visiting QoS flow information),
capable of configuring UE and/or UPF with QFM information;
F130: triggering and enforcing the start and stop of QoS flow migration:
activating or deactivating QFIs (or exceeding traffic of a QFI) migration among paired PDU sessions based on QFM information,
notifying AF about the activation or deactivation of QFM capability.

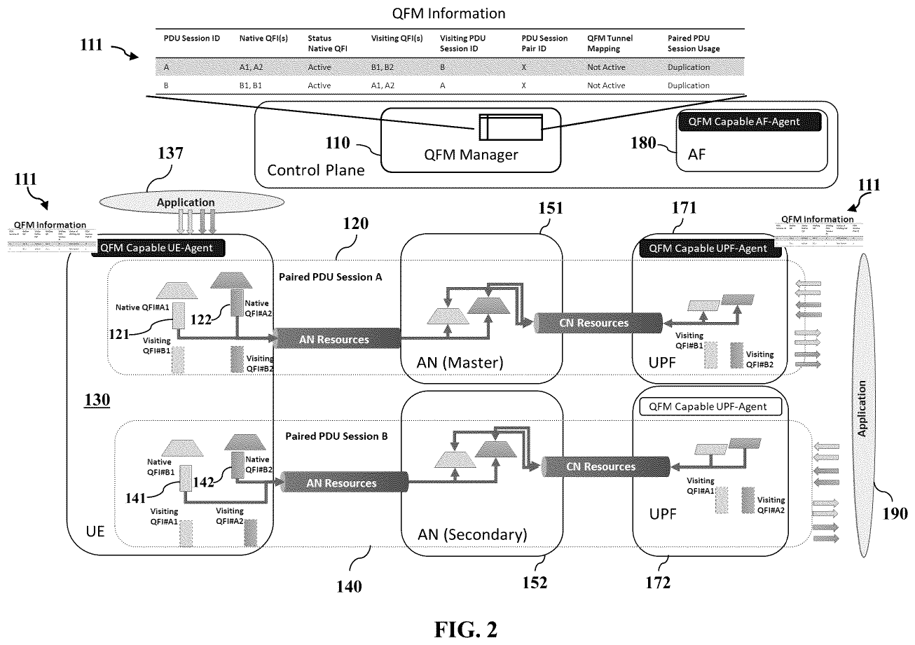

FIG. 2 shows an example of a system according to the present disclosure. The system shown in FIG. 2 may be built based on the system shown in FIG. 1. Corresponding elements in FIG. 1 and FIG. 2 may share the same features and function likewise.

In the control plane, a QFM manager 110 may be a new CP network function (NF), or may be comprised in an existing CP NF (such as a PCF or SMF). Thus, any CP NF with the functionality of the QFM manager may be simply referred to as the QFM manager. An AF 180 is also extended with the QFM Capable AF-Agent to support the exchange of information related to QFM. The UE 130 and UPF 171/172 are respectively extended with the QFM Capable UE-Agent and QFM Capable UPF Agent. The extensions in the UE 130 and UPF 171/172 allow such entities to support receiving and processing the QFM information 111 and to enforce the migration of QoS Flows (e.g., an entire QoS flow or the exceeding traffic of a QOS Flow) from one PDU session into another appropriate QoS Flow of the paired PDU session based on the QFM information 111. As a result, the duplication of traffic in the QoS Flows in paired PDU sessions is stopped.

The QFM manager 110 may be configured with one or more of the following capabilities:
F201: obtaining from the AF, and/or from other CP Function, and/or per configuration the QFM Capable indication. The QFM Capable indication determines that a UE, and/or a PDU session, and/or a pair of PDU sessions, and/or an application, and/or for one or more flow descriptors (or flow descriptions), and/or for one or more flows can operate (i.e., has the possibility, or is able to be configured) with the QFM capability. The QFM capability defines the possibility of changing (or switching) between data transmission using paired PDU sessions for the duplicated data packets (e.g., duplicated or redundant usage of paired PDU sessions for the data traffic, aka duplicated or redundant transmission) into data transmission using both paired PDU sessions for data packets without duplication (e.g., parallel or simultaneous usage of paired PDU sessions for data packets without duplication, aka, parallel or simultaneous transmission), and vise-versa. This switching can further enable the use of the resources from one or more flows of one of the paired PDU sessions to stop the duplication of packets and enable the switching of the entire data traffic of a QoS flow or the exceeding data traffic of one QOS flow to be transmitted in the QoS flow of the paired PDU session for the same UE and being served by two RAN nodes both with the same type of RAT;
F202: managing QoS flows with QFM capability based on (e.g., using, or controlling, or operating with) the QFM Information for each paired PDU session. The QFM information defines the mapping between a flow in one of the paired PDU sessions to a flow in the other paired PDU session. Both of the paired PDU sessions are identified as QFM capable;
F203: providing the QFM information to the SM Entities related to the paired PDU session;
F204: obtaining an indication for the activation (or deactivation) of QFM capability for a UE, and/or a PDU Session, and/or a pair of PDU sessions, and/or an application, and/or for one or more flow descriptors (or flow descriptions), and/or for one or more flows;
F205: determining QFM Activation Information based on the indication for the activation or deactivation of QFM capability and/or the QFM information. The QFM activation information defines the changes in the usage of the resources (flows, or QoS Flows) of the paired PDU session to switch from duplicated to parallel usage (or vice-versa) of such resources; and
F206: provide the QFM Activation Information to the SM entities related to the paired PDU sessions.

Optionally, the QFM manager 100 may be further configured with one or more of the following optional capabilities.
F207: The QFM manager may be further adapted to provide the AF with an indication of QFM status that describes where for UE, and/or a PDU session, and/or a pair of PDU sessions, and/or an application, and/or for one or more flow descriptors (or flow descriptions), and/or for one or more flows related to the AF, a configuration of QFM capability has been enforced (or executed); or if an activation or deactivation of QFM capability has been executed for switching between duplicated to parallel use of the paired PDU sessions for the data transmission (or vise-versa).
F208: The QFM Manager may be further adapted to obtain the QFM Capable indication. The QFM capable indication may be obtained in one of the following possible ways:
a) by retrieving from UDM the subscription information extended with the QFM subscription Information. In this case, the QFM Capable indication is the QFM subscription information.
b) by receiving directly from AF (or via other control plane functions forwarding or serving as intermediary CPs between SMF and AF) the QFM AF indication. In this case, the QFM capable indication is the QFM AF indication.
c) via UE policy association. For instance, the UE registration procedure is extended with UE providing the QFM indication. The AMF triggers at PCF the UE Policy Association procedure extended with the QFM indication. PCF triggers the extended UE configuration update procedure to provide the QFM policy to the UE that contains QFM policy indication and/or QFM conditions during UE registration in the network.
F209: The QFM Manager may be triggered by the QFM indication from a SM entity (e.g., UE) to request, or subscribe or query further CP entities for obtaining the QFM capable indication.
F210: The QFM Manager may be adapted to obtain the indication for the activation (or deactivation) of QFM capability in one of the following possible ways:
a. QFM Manager identifies based on the QFM conditions and/or and local information and/or local policies and/or local monitoring of the data traffic related to the paired PDU sessions with QFM Capability.
b. Obtain from at least one SM Entity related to paired PDU session with QFM Capability, a Network-triggered Candidate QFM Activation Information.
c. Obtain from the AF an AF-triggered Candidate QFM Activation Information switching between duplicated to parallel transmission (or vice-versa) in the paired PDU sessions.
F211: The QFM Manager may be adapted to obtain the QFM conditions in one of the following possible ways:
a) configured with the QFM conditions (e.g., as local policies of the QFM Manager);
b) together with the QFM subscription Indication;
c) together with QFM AF Indication;
d) together with the QFM Policy Indication; and
e) retrieved during SM Policy association.
F212: The QFM information determined by the QFM manager may comprise (among other information):
a) the Native QFIs (or QoS Flow) information (i.e., information related to one of the paired PDU sessions defining the QoS flows or QFI(s) that have been requested and established for such PDU session); and
b) Visiting QFI(s) (or QoS Flows) information (i.e., define QoS Flows or QFI(s) that are related to the Native QoS Flows, e.g., have the same and/or equivalent QoS requirements as the Native QoS Flows, but have been requested and established at the paired PDU Session).
F213: The QFM Manager may be configured to obtain a QFM Policy. The QFM Policy defines that a QFM capability should be activated for a QFM policy filter and/or the QFM conditions for the activation and/or deactivation of QFM capability for the paired PDU session associated with QFM Information. The QFM policy may be obtained in one of the following ways:
a) through local decision-making (or based on local policies). The QFM Manager identifies the need to define a QFM Policy, and define its parameters;
b) by receiving the QFM Policy from a further CP entity (e.g. PCF) capable of defining policies in the network; and
c) by checking and requesting a further CP entity (e.g. PCF) capable of defining policies in the mobile network if there exists any QFM policy to be applied to the UE and/or paired PDU session.
F214: QFM Manager may be further configured to provide the QFM policy to the SM entities.
F215: QFM manager may be further configured to receive an indication for the activation of QFM Capability. The indication for the activation of QFM Capability may be determined by an SM entity based on the QFM Policy and/or monitoring information. The indication for the activation of QFM Capability may comprise the Network-triggered Candidate QFM Activation Information.

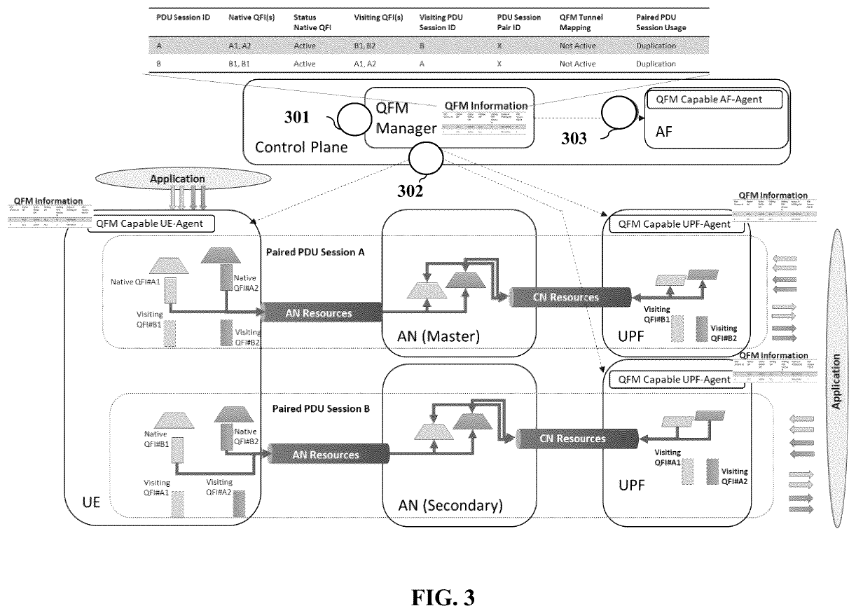

FIG. 3 shows an example of steps performed by the QFM manager according to the present disclosure. The system in FIG. 3 may be built based on the system in FIG. 1 and FIG. 2. In FIGS. 1-3, corresponding elements may share the same features and function likewise. For the sake of simplicity, reference signs of the elements that are the same as the elements in FIG. 1-2 are omitted in FIG. 3.

FIG. 3 depicts three exemplary steps. Step 301 in FIG. 3 illustrates a new capability of a QFM manager to bind QoS Flows in preparation for the activation or deactivation of QFM Capabilities (also referred to as Feature F310). Steps 302 and 303 depict a new capability of the QFM manager to provision QFM Information to entities of the network.

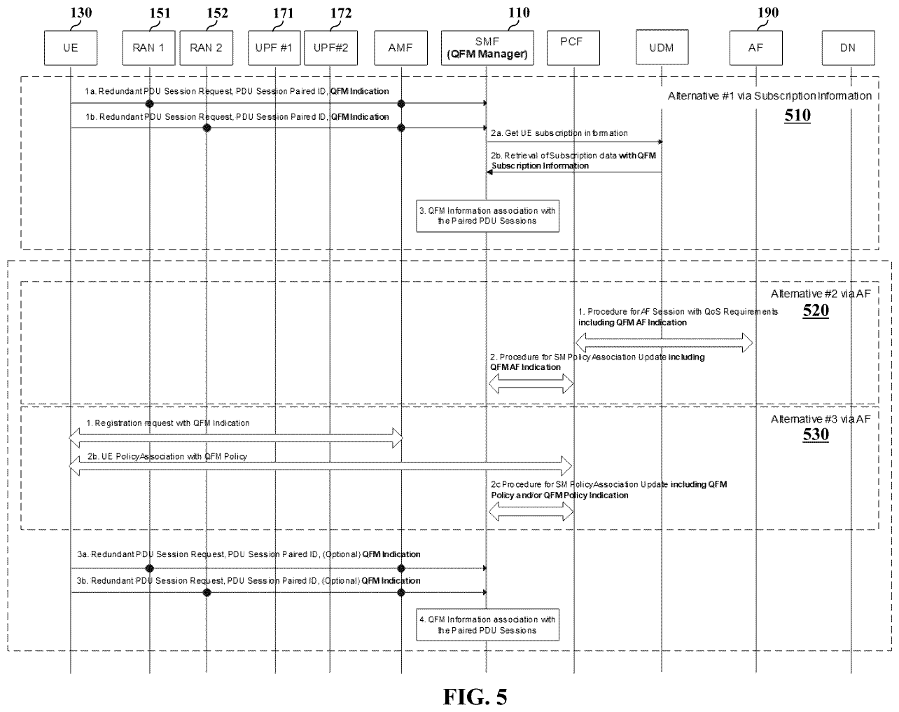

Step 301: For every Service Request in one PDU Session (e.g., PDU Session A) and/or for a PDU Session Request, the QFM Manager is configured to:
a) identify if QFM Capability is supported and should be activated for the UE and/or QoS Flows of requested paired PDU Sessions, and/or specific QoS Flow, and/or Application. The QFM Manager uses the information in the PDU session establishment (and/or service request) to check the QFM capability. There may be different options for checking the QFM capability, which is further with respect to FIG. 5.
b) in response to determining that the QFM Capability should be activated related to the PDU Session, configure the QFM Information for enabling the mapping among the QoS Flows of the paired PDU Sessions.

Step 302: During the configuration of a QoS Flow in one PDU Session, the QFM Manager may be configured to provide (or configure) the QFM information to the SM Entities (e.g., UE and/or UPFs related to paired PDU Sessions).

Step 303: QFM Manager may be configured to provide (e.g., inform or notify) the AF with the indication of QFM Status. The indication of QFM Status informs the AF that a QFM Capability has been configured for the UE, and/or a PDU Session, and/or a Pair of PDU sessions, and/or an Application, and/or for one or more flow descriptors (or flow descriptions), and/or for one or more flows related to the AF.

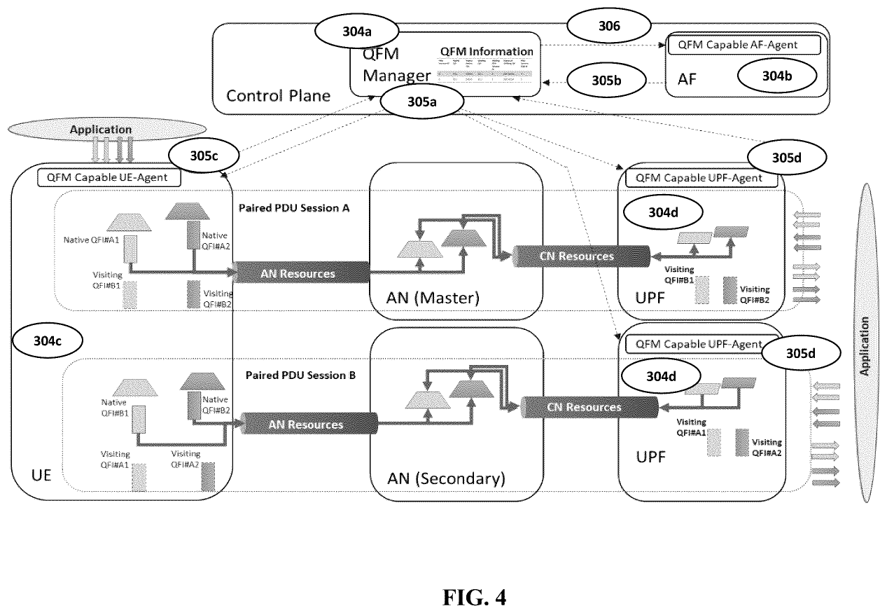

FIG. 4 shows an example of interactions among entities according to the present disclosure. The system in FIG. 4 may be built based on the system in FIGS. 1-3. In FIGS. 1-4, corresponding elements may share the same features and function likewise. For the sake of simplicity, reference signs of the elements that are the same as the elements in FIG. 1-2 are omitted in FIG. 4.

FIG. 4 depicts interactions among entities to enable the new capability for activating or deactivating the usage of QFM Capabilities in the paired PDU sessions with QFM Information. There may be three possible main steps 304, 305, 306 that are executed in order to perform the activation or deactivation of the QFM Capability for a paired of PDU sessions with QFM Information (or configured or associated with a QFM Information).

Step 304 (304a-d): An entity may be adapted to monitor data traffic and QoS fulfillment conditions in the paired PDU session (which can be performed with the mechanism defined in TS 23.501, for instance).

Step 305 (305a-d) may comprise three actions performed by a corresponding entity: the determination of the need to activate or deactivate the QFM Capability for a paired PDU session; the definition of the QFM Activation Information; the configuration of SM entities (UE and related UPFs) with the QFM Activation Information;

Step 306: The QFM Manager may be configured to inform the AF with the Indication of QFM Status describing the activation of the QFM capability for the paired PDU Session.

For steps 304 and 305, there may be different implementation forms 304a-d, 305a-d:
Option 310 (QFM Manager Triggered QFM Capability): In this case, steps 304, 305, and 306 are executed by the QFM manager, which are referred to as 304a, 305a, and 306.
Option 320 (SM Entity Triggered QFM Capability): In this case, the UE and/or the UPFs, in steps 304 and 305, which are referred to as steps 304c and 304d, identifying the need are respectively configured to activate the QFM capability for a paired PDU sessions with QFM information. The UE and/or the UPFs may be configured to determine the Network-triggered Candidate QFM Activation Information with a suggestion (or proposal) of the QFM Information changes to enable the switch from duplicated to parallel (or parallel to duplicated) data traffic transmission, respectively, in steps 305c and 305d. The UE and/or the UPFs may be configured to provide such information to the QFM Manager. Step 305a related to the definition of the QFM Activation Information and the configuration of SM entities (UE, and related UPFs) with the QFM Activation Information are executed by the QFM Manager. The QFM Manager executes step 306.
Option 330 (AF Triggered QFM Capability): In this case, the AF executes step 304 (which is referred to as step 304b) for monitoring the UE, and/or a PDU Session, and/or a pair of PDU sessions, and/or an application, and/or one or more flow descriptors (or flow descriptions), and/or one or more flows related to the QFM Information. In step 305 (which is referred to as step 305b), the AF is configured to determine the need to trigger a QFM Capability activation or deactivation and provide such indication (e.g., an indication of the activation or deactivation of QFM Capability) to the QFM manager. The QFM manager executes the other tasks described in step 305 (or 305a) such as the definition of the QFM Activation Information and the configuration of SM entities (UE, and related UPFs) with the QFM Activation Information. The QFM Manager executes also step 306.

Generally, in these three options, for activation or deactivation of the QFM Capability, a common feature is the definition of information to enable the actual migration of data traffic among the paired PDU sessions. Further, the effect in the system after the activation or deactivation of the QFM Capability is the same for all these options.

Applicable to all three options, the QFM Activation information for activating the switch from duplicated to parallel usage of paired PDU sessions may comprise one or more of the following:
Type of QFM Capability activation: switching from duplication to parallel usage of paired PDU sessions,
Selected source and target PDU sessions among the paired PDU sessions,
Selected one or more native QFI(s) of the source PDU session,
Selected one or more visiting QFI(s),
Selected one or more native QFI(s) at the target PDU session to have the transmission of their duplicated data traffic stopped,
Mapping of selected native QFI to the one or more selected visiting QFI(s) where duplication of traffic will be stopped and the transmission of data traffic related to the native QFI will be started,
Type of data traffic migration: defines how the data traffic of the native QFI will be migrated to the visiting QFI (e.g., to the QFI from the paired PDU session).

The type of data traffic migration may indicate one of the following:
all traffic from the selected native QFI is rerouted to one selected visiting QFI. This possibility is a response when the RAN node serving the native QFI cannot provide the needed QoS requirements via the PDU session over that RA node, and the other RAN node,
exceeding traffic from the configured bit rate for the native QFI is transmitted in the one or more selected visiting QFI (e.g., a further split of the exceeding data traffic could also apply if more than one visiting QFIs are needed to support the native QFI).

The QFM Activation information for deactivating the switch from parallel to duplicated usage of paired PDU sessions may comprise one or more of the following:
Type of QFM Capability activation: from parallel to duplication usage of paired PDU Sessions,
List of one or more visiting QFI(s) at the source PDU session being used for the parallel data traffic transmission related to the selected native QFI that will have the mapping to such native QFI removed, and
Selected one or more native QFI(s) at the target PDU session to have the transmission of their duplicated data traffic restarted.

When the QFM Activation Information comprises the indication to switch from duplicated (or redundant) to parallel usage of the paired PDU session, the QFM Activation information is equivalent to a first switch information. When the QFM Activation Information comprises the indication to switch from parallel (or simultaneous) to duplicated (or redundant) usage of the paired PDU session, the QFM Activation information is equivalent to a second switch information.

It is also possible that the QFM Activation information (when activating the QFM flow migration, e.g., the first switch information) comprises a modified QFM Information (e.g., a changed mapping of tunnel information if compared with the QFM information that has been determined before the identification of the need to activate the QFM capability or the activation of the QFM capability, e.g., the original QFM information). When the deactivation of the QFM capability is enforced, it is possible that the QFM Activation information comprises the original QFM information (e.g., the previously defined QFM information for the PDU session pair before the activation of the switch to the parallel transmission).

Optionally, the QFM Activation Information may further comprises one or more of the following:
a confirmation that the obtained Network-triggered or the AF-triggered Candidate QFM Activation Information can be used without any changes,
an updated Network-triggered or the AF-triggered Candidate QFM Activation Information, as the QFM Manager determines that the obtained information from SM Entity and/or AF cannot be used without changes, and then the QFM Manager updates the appropriated fields and derive the updated QFM Activation Information, and
a rejection of the obtained Network triggered and/or AF-triggered Candidate QFM Activation Information which indicates to the SM Entity or to the AF that the activation of QFM Capability cannot be performed with the obtained information.

For steps 303 and 306, the SMF may be adapted to expose the QFM Capability as a new event type. a consumer of this event may subscribe to it using the event type set to “QFM Capability”, and further optional parameters of the subscription may include one or more of the information listed in the QFM AF Filters.

The information that is enclosed in the notification that SMF generates to the consumer determines that for the given QFM AF filter information of the subscription, the SMF is configured to notify the consumer with one or more of the following information:
QFM Capability is allowed;
QFM Capability is activated; and
QFM Capability is deactivated.

There are different possibilities for the QFM Capability event notification to reach the AF. For instance, it may be done with the extension of the Nnef_AFsession WithQoS_Notify service exposed by NEF using the same mechanisms defined for the exposure of PCF notifications to the AF. In this case, the PCF is required to subscribe to the QFM Capability event exposed by the SMF. This information may be then passed from the PCF to the NEF and finally to the AF. Alternatively, if the AF is a trusted NF by the operator, such AF could subscribe directly to the SMF to consume such information.

FIG. 5 shows examples of obtaining QFM information according to the present disclosure. FIG. 5 may be built based on the features disclosed in FIGS. 1-4. In FIGS. 1-5, corresponding elements may share similar features and function likewise.

FIG. 5 illustrates possible procedures for a control plane entity functioning as a QFM Manager (e.g., the SMF 110 in FIG. 5) to obtain useful information to determine if a QFM Capability should be used for a paired PDU session. In some other examples, a PCF may function as a QFM manager. FIG. 5 illustrates different optional implementations of step 301.

Generally, the SMF may be configured to verify the QFM capability via Subscription Information (Alternative 510) or via AF (Alternative 520 and Alternative 530). As shown in FIG. 5, steps 1 to 3 in the top part illustrate interactions related to Alternative 510. Steps 3(a, b) and 4 in the bottom illustrate the interactions related to Alternatives 520 and 530 for the SMF 110 to be ready to evaluate if a QFM Capability should be activated for paired PDU Sessions. In this case, the SMF at Step 4 obtains the information useful to determine that the paired PDU session is allowed (or not) to use the QFM Capability.

Even if the SMF does not receive explicitly the paired PDU session identification in Alternative 520 or Alternative 530: based on at least the UE information and/or the flow description and/or the application information received from AF and/or PCF, the SMF can in Step 4 of Alternatives 520 and 530 map the information from the PDU session request in Step 3(a, b), such as UE information, and the indication for using redundant transmission (e.g. the Paired PDU Session ID), to the information it received from AF or PCF in Step 2 of Alternative 520 to determine that the requested paired PDU Sessions for the UE are allowed (or not) to use QFM Capability. In the following, step X of Alternative Y may be referred to as step Y-X. Since steps 3a, 3b, 4 in the bottom part of FIG. 5 may be shared by Alternatives 520 and 530, they are referred to as steps 523-3a, 523-3b, 523-4.

Optionally, QFM indication may be used in steps 510-1(a, b) and 523-step 3(a, b). The QFM indication is a parameter that may be included in the information the UE (e.g., as an SM Entity) sends to the core network, e.g., through the PDU session request via the RAN node and AMF (N2 container) or via UE registration procedures. The SMF may be configured to receive the QFM indication. This parameter may be implemented as a flag that indicates to the SMF that the UE requesting the PDU session is requested to use the QFM Capability for the paired PDU session(s). When the QFM indication is sent in a UE registration, such information reaches the SMF during SM Policy Association procedures. The QFM indication may also be referred to as flow migration trigger indication.

In the case of Alternatives 510 and 530, the SMF checks if a QFM Capability should be activated for a paired PDU session at the moment that it receives the PDU session request (and then perform the check on the subscription information or receive the information related to the SM Policy Association). Nevertheless, in the Alternative 520, a PDU session may or may not be set up when the SMF receives the QFM AF indication.

It is noted that Alternative 520 is not exclusive and it may be executed even if the UE and SMF can operate with the other alternatives. For instance, the UE may request a PDU session without the QFM Indication. The AF may decide that the QFM capability should be activated for a paired PDU session (or a set of flow descriptions) of the UE. Accordingly, the AF provides the QFM AF Indication that allows the SMF to change the PDU session to enable the usage of QFM Capability and QFM Information for the paired PDU sessions.

Details of information in each alternative are explained as follows.

### Alternative 510—Via Verification of Subscription Information

The SMF, by interacting with the UDM or PCF interacting with UDR, retrieves subscription information extended with the QFM Subscription Information. For instance, the Session Management Subscription data in UDM may be extended with the QFM Subscription Information and/or the QFM Conditions. The QFM Subscription information may also be referred as flow migration subscription indication.

Alternative 510 may comprise the following steps:
Step 510-1a: UE 130 may be configured to provide Redundant PDU Session Request, PDU Session Paired ID, QFM Indication to SMF 110 through a first RAN 151 and AMF.
Step 510-1b: UE 130 may be configured to provide Redundant PDU Session Request, PDU Session Paired ID, QFM Indication to SMF 110 through a second RAN 1552 and AMF.
Step 510-2a: The SMF may be configured to provide UE subscription information to UDM.
Step 510-2b: The SMF may be configured to receive subscription data with QFM subscription information.
Step 510-3: The SMF may be configured to determine QFM information. The QFM information may be associated with the paired PDU sessions.

The QFM Subscription Information may be used by the SMF to determine whether the QFM Capability is allowed for one or more of the following QFM Filter information:
UE identification (e.g., SUPI);
one or more application information;
one or more Data Network information (e.g., DNN and/or DNAI);
one or more Network Slices (e.g., S-NSSAI);
one or more PLMN identification (e.g., PLMN ID);
one or more PDU Session identification;
the identification of a Pair of PDU sessions;
one or more flow descriptors (or flow descriptions); and
one or more flow identification.

For instance, the SMF as the QFM manager may send a request to UDM using the service Nudm_SDM_Get with input parameters including one or more of the following: SUPI, selected DNN, S-NSSAI of the HPLMN, Serving PLMN ID. As a response, the SMF receives Session Management Subscription data with the QFM Subscription information. This means that for any indicated input parameters in the service (e.g., UE, selected DNN, S-NSSAI, PLMN ID) or a combination thereof, the QFM Capability is allowed to be used. Therefore, when SMF receives PDU session requests with an indication for a paired PDU session for redundant transmission including the same values for any one of UE ID (SUPI), DNN, S-NSSAI, and PLMN ID, the SMF is allowed to activate the QFM Capability, and define the QFM Information to be used with the paired PDU session.

The same principle applies if PCF is the QFM Manager and the PCF retrieves from UDR the subscription information via the Nudr_DM_Query service operation.

The QFM Subscription Information may be implemented according to one or more the following options:
a flag (e.g., QFM Allowed) indicating that QFM Capability is allowed for any of the QFM filter parameters included in the service for retrieving the subscription information (e.g., SUPI, DNN, S-NSSAI, PLMN ID)
a flag (e.g., QFM Denied) indicating that QFM Capability is not allowed for any of the QFM filter parameters included in the service for retrieving the subscription information (e.g., SUPI, DNN, S-NSSAI, PLMN ID)
a flag (e.g., QFM Allowed) and a list of QFM filter, which indicate that QFM Capability is allowed for the given QFM filter information. For instance, QFM may be allowed for a UE ID and a DNN.
a flag (e.g., QFM Denied) and a list of QFM filters, which indicate that QFM Capability is not allowed for the given QFM filter information. For instance, QFM may not be allowed for a UE ID and DNN.

### Alternative 520—Via AF Providing Information to Control Plane

The AF is able to provide information for the control plane using the service Nnef_AFsessionWithQoS service via NEF and/or Npcf_Policy Authorization service via PCF. The AF providing information to the control plane includes, in the request or update of the AF session identified by the Transaction Reference ID (or by other means of identifying the application and its associated QoS Flows), the QFM AF indication and/or QFM Conditions.

The information provided by the AF is either stored at PCF such that it can be transferred to the SMF (QFM Manager) during SM Policy Association; or stored in NFs such as UDM or UDR such that it can be retrieved by SMF when needed.

Alternative 520 may comprise the following steps:
Step 520-1: PCF and AF establish an AF session with QoS requirements including QFM AF indication.
Step 520-2: Procedure between SMF 110 and PCF for SM Policy Association Update including QFM AF indication.
Step 523-3a: UE 130 may be configured to provide Redundant PDU Session Request, PDU Session Paired ID, and optional QFM Indication to SMF 110 through the first RAN 151 and AMF.
Step 523-3b: UE 130 may be configured to provide Redundant PDU Session Request, PDU Session Paired ID, and optional QFM Indication to SMF 110 through the second RAN 1552 and AMF.

The QFM AF indication may be used by the SMF to determine whether the QFM Capability is allowed for any of the following QFM AF Filters:
application information (e.g., Application ID, External Application Identifier);
data network information (e.g., DNN, and/or DNAI);
UE information (e.g., IP address or MAC address or SUPI);
One or more flow descriptions (e.g. source IP address, destination IP address, port numbers, the protocol information);
Identification of the application session context;
Identification and/or reference of an AF session;
Transaction Reference ID;
Paired PDU session Identification;
Indication of paired flow description;
One or more PDU session Identification; and
One or more Network Slices (e.g., S-NSSAI).

The QFM AF indication may be implemented according to one or more the following options:
a flag (e.g., QFM Allowed) indicating that QFM Capability is allowed for any of the QFM AF filter parameters included in the service(s) for creating or updating a AF session.
a flag (e.g., QFM Denied) indicating that QFM Capability is not allowed for any of the QFM AF filter parameters included in the service(s) for creating or updating a AF session.
a flag (e.g., QFM Allowed) and a list of QFM AF filter, that indicates that QFM Capability is allowed for the given QFM AF filter information included in the service(s) for creating or updating an AF session.
a flag (e.g., QFM Denied) and a list of QFM filter, that indicates that QFM Capability is not allowed for the given QFM AF filter information included in the service(s) for creating or updating an AF session.

The QFM AF indication may also be referred to as flow migration application function indication.

### Alternative 530—Via UE Policy Association

UE provides, e.g. during the registration procedure, the UE Policy Container comprising the QFM indication. The same QFM indication defined for Alternatives 510 and can be reused. In Alternative 530, the QFM indication first reaches the PCF. The PCF is able to (e.g., by retrieving subscription information related to policy data) determine that the UE should be provisioned with a UE Policy which includes the QFM Policy.

The QFM indication at the registration is the trigger for the PCF (with or without the QFM Manager capability) to define the QFM Policy. The PCF requests from UDR the policy data information associated with the UE subscription. Such policy data information at UDR is extended with the QFM Policy indication and/or QFM Conditions.

Alternative 530 may comprise the following steps:
Step 530-1: UE 130 performs UE registration with QFM indication.
Step 530-2b: UE 130 performs UE policy association with QFM policy.
Step 530-2c: Procedure between SMF 110 and PCF for SM (UE) Policy Association Update including QFM AF indication.
Step 523-3a: UE 130 may be configured to provide Redundant PDU Session Request, PDU Session Paired ID, and optional QFM Indication to SMF 110 through the first RAN 151 and AMF.
Step 523-3b: UE 130 may be configured to provide Redundant PDU Session Request, PDU Session Paired ID, and optional QFM Indication to SMF 110 through the second RAN 1552 and AMF.

The QFM Policy indication determines the QFM Capability is allowed for one or more of the following QFM Policy Filters:
Application information (e.g., Application ID, External Application Identifier)
Data Network information (e.g., DNN, and/or DNAI)
UE information (e.g., IP address and/or MAC address and/or SUPI)
One or more Network Slices (e.g., S-NSSAI)

The SMF (QFM Manager) may either obtains the QFM Policy from the PCF or determines a QFM Policy based on information provided by PCF, URD or UDM to the SMF. QFM Policy indication may also be referred to as a flow migration policy indication.

The following existing procedures at the network may be extended as follows:
a) UE Registration Procedure may be extended with UE providing the QFM Indication in the UE Policy Container;
(b) AMF triggers at PCF the UE Policy Association procedure extended to include the UE Policy Container with the QFM indication;
c) the PCF, when receiving such request from AMF, triggers the extended UE Configuration Update Procedure to provide the QFM Policy to the UE.

The QFM Policy indication in this Alternative 530 may comprise information related to allowing or restricting the QFM Capability comprising any of the following:
a flag (e.g., QFM Allowed) that indicates that QFM Capability is allowed for any of the QFM Policy filter parameters included in the service(s) for creating or updating a UE Policy.
a flag (e.g., QFM Allowed) and a list of QFM Policy filter, that indicates that QFM Capability is allowed for the given QFM Policy filter information included in the service(s) for creating or updating a UE Policy.
a flag (e.g., QFM Denied) and a list of QFM Policy filter, that indicates that QFM Capability is not allowed for the given QFM Policy filter information included in the service(s) for creating or updating a UE Policy.
a flag (e.g., QFM Denied) and a list of QFM filter, that indicates that QFM Capability is not allowed for the given QFM AF filter information included in the service(s) for creating or updating a UE Policy.

The QFM Conditions may comprise one or more parameters that can be used in Alternatives 510, 520, 530. The QFM Conditions can be provided to the a QFM Manager (e.g., SMF) 110 together with the information delivered in Alternatives 510 and 520. It is also possible that the SMF is configured with the QFM conditions but will only use such information during the activation or deactivation of QFM Capability. In the case of Alternative 530, it is possible that the QFM Conditions are stored in UDR. When PCF is triggered to define the UE Policy, it requests from UDR the Policy Data that comprises the QFM Conditions.

The QFM Conditions may comprise information (e.g., parameters, and/or parameters and associated values, and/or monitored information) related to the decision (or triggers or information) to activate or deactivate the QFM Capability. For instance, the QFM Conditions may comprise one or more of the following information:
Upper threshold for the QoS related measurements, which defines that if the upper threshold for one or more of the QoS related measurements, the QFM Capability should be activated;
Lower threshold for the QoS related measurements, which defines that if the upper threshold for one or more of the QoS related measurements, the QFM Capability should be deactivated;
Maximum interval of time that a QFM Capability can be activated (i.e., duplication of data packets is stopped in one of the paired PDU sessions and the QoS Flow(s) of such PDU session are used for simultaneous data transfer in both paired PDU sessions, i.e., without duplication of packets in any of the PDU sessions);
Minimum interval of time that a QFM Capability can be activated (i.e., duplication of data packets is stopped in one of the paired PDU sessions and the QoS Flow(s) of such PDU session are used for simultaneous data transfer in both paired PDU sessions, i.e., without duplication of packets in any of the PDU sessions);
Reliability degradation threshold that indicates the lowest tolerable reduction on reliability for the data transmission when QFM Capability is activated (When this threshold is crossed the QFM capability should be deactivated);
Upper threshold for the QoS related measurements, which defines that if the upper threshold for one or more of the QoS related measurements, the QFM Capability should be activated; and
A QOS related measurement is information monitored and/or calculated indicating a certain value for the QoS parameter itself and/or the QoS fulfilment information related to a QOS flow.

Optionally, the QoS related measurements may comprise one or more of the following: buffered data traffic for a flow, peak bit rate, PDB (Packet Delay Budget), packet jitter, drop rate, number of GFBR notification control messages, PER (Packet Error Rate), and, Session-AABR (Aggregate Average Bit Rate).

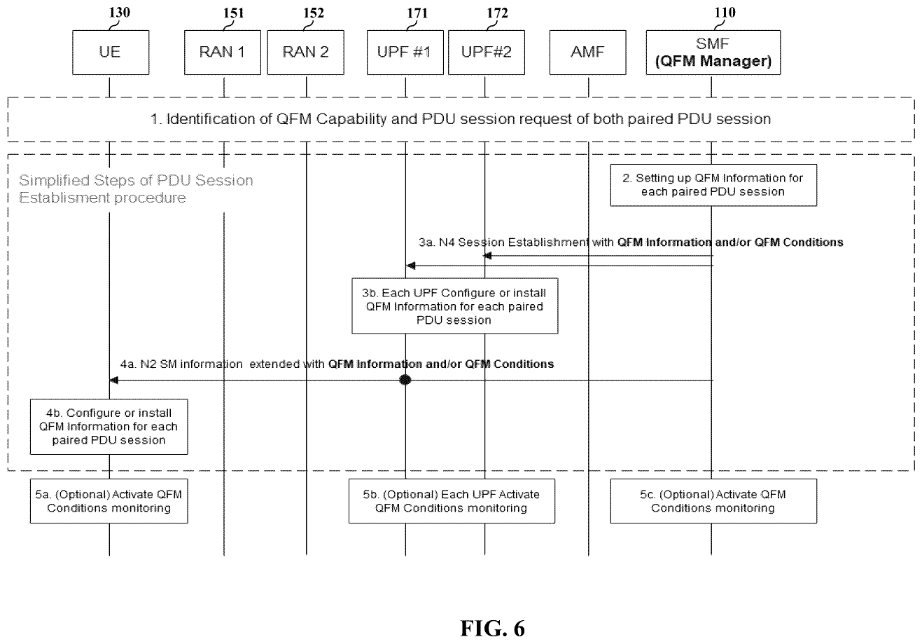

FIG. 6 shows an example of QFM information provisioning according to the present disclosure. FIG. 6 may be built based on the features disclosed in FIGS. 1-5. FIG. 5 illustrates optional features for executing step 302. In FIGS. 1-6, corresponding elements may share similar features and function likewise.

As shown in FIG. 6, a SMF as a QFM manager 110 determines that a QFM Capability is to be activated for a pair of PDU session for a UE 130 as in step 1 of FIG. 6. The SMF receives the request for PDU session establishment of a pair of PDU sessions to be used for redundant transmission with QFM Capability. The SMF is configured to set up the QFM information for each of the paired PDU sessions as in step 2 of FIG. 6. The details of possible implementation forms for the QFM Information are described further in the description.

Once the QFM information is setup, the SMF is configured to provide such information to the SM entities related to such PDU sessions. Examples of SM entities may be: the UPF(s) and the UE associated with the pair of PDU sessions.

During the N4 Session establishment procedure, the SMF is configured to provide to the UPF(s) of each PDU session the appropriated QFM Information as in step 3a in FIG. 6. Optionally, the QFM Conditions may be also provided by the SMF if the UPF is supposed to determine the activation of the QFM Capability. The UPFs (e.g., comprising a QFM Capable UPF-Agent) receive the QFM Information and setup the appropriated mapping among CN tunnels as in step 3b of FIG. 6.

The SMF provides to the UE, via AMF N2 transfer message procedure, the QFM Information for each of the paired PDU sessions of such UE. UE. The Namf_Communication_N1N2MessageTransfer service at AMF and the NAS Signaling between AMF and UE are both extended to include the QFM Information and/or the QFM Conditions as in step 4a of FIG. 6. The UE is adapted to configure the QFM information (e.g., using the QFM Capable UE-Agent to perform the task).

Further, if the UE and/or the UPF are supposed to perform the monitoring and triggering of the QFM activation, both the UE and the UPF are configured to start the monitoring of the QFM Conditions (as in steps 5a and 5b of FIG. 6). This may correspond to the SM Entity Triggered QFM Capability introduced in FIG. 3. If QFM Manager Triggered QFM Capability introduced in FIG. 3 is used, the SMF starts the monitoring of the QFM conditions for the pair of PDU sessions (as in step 5c of FIG. 6).

The PDU Session information comprises useful information to enable the SMF to control the path from UE to Data Network (DN, e.g., DNN) and other optional characteristics (e.g., QOS Requirements, routing policies, redundant transmission). The SMF controls some important information (besides the QoS related information) in the PDU Session as described below:
PDU Session ID,
PDU Session Pair ID (or Paired PDU Session ID),
QOS Flow ID (QFI), as it identifies the flow where the data traffic is being transported or is associated with;
Associated N3 (e.g., path or link between a RAN node and one UPF), optionally N9 (path or link between two or more UPFs), and N6 (path or link between UPF and DN) CN tunnels for the PDU Sessions and/or for each QFI,
CN Tunnels (or CN tunnel identification, or CN Tunnel Info) related to a QFI and/or a PDU Session that are being used for redundant transmission, and
RAN node associated with the QFI (which can also be known to SMF by the mapping of N3 to a RAN node).

The UE (e.g., SM entity) also controls important information related to the flows of a PDU session, for instance, as one or more of the following:
PDU Session ID,
PDU Session Pair ID (or Paired PDU Session ID),
QOS Flow ID (QFI), as it identifies the flow where the data traffic is being transported or is associated with, and
RAN Tunnel information (e.g., DRBs—Data Radio Bearer or AN resources, such as Primary Cell, Secondary Cell, Primary Secondary Cell) used for the data traffic of the UE QFIs) that can be used for data traffic associated with the QFIs of a UE.

Thus, the QFM information may be used to map (or link, or associate) the CN Tunnel Information and/or the RAN Tunnel Information from one PDU Session to the other PDU session when the two PDU sessions share the same PDU Session Pair ID and one of such PDU Sessions is used for redundant transmission (e.g., transmission of duplicated data traffic of the UE).

In the present disclosure, possible implementations for the QFM Information may be based on the definition of the logical flows: Native and Visiting QoS flows (or flows, or QFIs). The logical flows (or flow abstraction(s) or logical concept(s) or logical reference(s) or virtual flow(s)) are references (or pointers) to enable cross link (or cross reference, or mapping) among a flow requested (and/or configured and/or established) at one PDU Session to be mapped into one or more flows in another PDU Session, where the two PDU session use the same Paired PDU session identification.

The native flow is used to identify the information of a QoS Flow (or flow or flow description or QFI) that has been requested and/or established and/or configured for one PDU session.

The visiting flow is used to identify the information of a QoS Flow (or flow or flow description or QFI) that has been requested and/or established and/or configured for the other paired PDU session.

For each PDU session requested and established with a paired PDU Session (e.g., identified via the PDU Session Pair ID) the SMF associates to this PDU session information and/or for each QoS Flow (or QFI or flow descriptor, or flow description) one or more of the following information that comprises the QFM Information based on this embodiment with the concepts of native and visiting QFI(s), as illustrated in FIG. 3:
List of native QFIs(s),
Status of each QFI(s),
List of Visiting QFI(s),
PDU Session Paired ID,
PDU Session ID of native QFI(s),
PDU Session ID of visiting QFI(s),
CN Tunnel Info for each Native QFI,
RAN Tunnel Info for each Native QFI,
QFM Tunnel mapping, which is the information defining the mapping of the data traffic from a native QFI to a visiting QFI.

Examples of QFM Tunnel mapping information may be a tuple comprising one or more of the following:
native QFI,
one or more visiting QFIs,
PDU Session ID of the visiting QFI(s),
PDU Session Paired ID,
type of data traffic migration, which possible examples of values are: move all data traffic, move data traffic exceeding bit rate, move a percentage of data traffic),
CN Tunnel info of visiting QFI(s),
RAN Tunnel info of visiting QFI(s), and
Paired PDU Session usage per native QFI(s), which defines whether a QFI is being used for duplication of data traffic or it is being used for the transmission of data packets that are not duplicated (i.e., simultaneous or parallel transmission).

A further possible implementation form of the QFM Information may be based on associating to the PDU session a simplified set of information based on the QFM tunnel mapping. In this case, for each PDU session associated with a PDU Session Paired ID, the QFM information may comprise one or more of the following:
List of QFI(s) from Paired PDU Session,
PDU Session ID of the paired PDU session,
PDU Session Paired ID,
CN Tunnel info of each QFI from Paired PDU Session,
RAN Tunnel info of each QFI(s) from Paired PDU Session, and
QFM Tunnel mapping, with a tuple comprising any of the following:
   One or more (or list of, or set of) mapping of a QFI to one or more QFI(s) from Paired PDU Session
   One or more (or list of, or set of) mapping of a CN Tunnel Info of a QFI to one or more CN Tunnel Info from one or more QFI(s) from Paired PDU Session
   One or more (or list of, or set of) mapping of a RAN Tunnel Info of a QFI to one or more RAN Tunnel Info from one or more QFI(s) from Paired PDU Session, and
   Type of data traffic migration, which possible examples of values are: move all data traffic, move data traffic exceeding bit rate, move a percentage of data traffic)

It is also possible that the type of data traffic migration may be information directly listed in the QFM information, not necessarily as part of the QFM tunnel mapping information. Furthermore, it is possible that the type of data traffic migration may be included, or have its values defined when the QFM Activation information is defined.

The concept of native and visiting flows may allow an exact mapping of the tunnel information (CN and RAN), i.e., the tunnel IDs to be abstracted. For instance, if a UE moves to a different RAN node and native/visiting abstractions are used, the UE (e.g., with the QFM-capable UE Agent) may update the tunnel ID information for the radio resources without having to make any change or notification to the SMF. Additionally, when the UE moves and the CN tunnel connecting the new RAN node serving the UE is not associated with a different N3 interface, there is no need for extra notification of changes in the CN tunnel IDs to update the QFM information. This change in the CN tunnels is also abstracted in the concept of native and visiting flows.

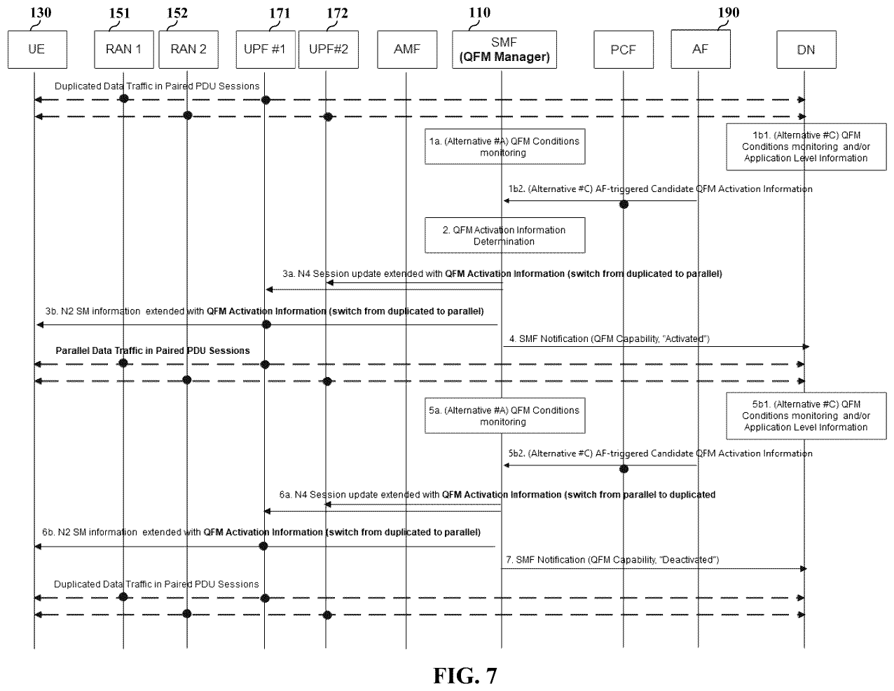

FIG. 7 shows an example of signaling of QFM manager triggered QFM capability (option 310) and AF triggered QFM capability (option 330). Features of FIG. 7 may be applicable to FIGS. 1-6.

Step 1 in FIG. 7 shows a main difference between option 310 (QFM Capability triggered by QFM manager) and option 330 (QFM Capability triggered by AF). The difference is in the entity performing the monitoring of the QFM Conditions or any other information related to the QoS Flows. For instance, Step 1b1 in FIG. 7 shows an AF identifying the need to trigger the QFM Capability activation. This activation is implemented via step 1b2 where the AF provides to the AF-triggered Candidate QFM Activation information to the SMF.

This exchange of information can be implemented for instance via indirect communication between AF and SMF (QFM manager) using PCF as intermediary NF. In this case, the AF uses the Nnef_AFsession WithQOS service via NEF and/or Npcf_PolicyAuthorization service via PCF including the information enclosed in the AF-triggered Candidate QFM Activation information. This information reaches the SMF once PCF provides an SM Policy Association update to SMF based on the received AF-triggered Candidate QFM Activation information (directly from AF or via NEF in the AF session with QoS procedure). In this case, the AF-triggered Candidate QFM Activation information to the SMF may comprise one or more of the following information:
Transaction Reference ID,
A flag indicating that the QFM capability activation of the switch from duplicated to parallel usage of the paired PDU sessions should be started,
A flag indicating that the QFM capability activation of the switch from parallel to duplicated to usage of the paired PDU sessions should be started,
Application information (e.g., Application ID, External Application Identifier),
Data Network information (e.g., DNN, and/or DNAI),
UE information (e.g., IP address or MAC address or SUPI),
One or more flow descriptions (e.g. source IP address, destination IP address, port numbers, the protocol information),
Identification of the application session context,
Paired PDU session Identification,
One or more PDU session Identification,
One or more Network Slices (e.g., S-NSSAI).

When the AF-triggered Candidate QFM Activation information comprises the indication to switch from duplicated (or redundant) to parallel usage of the paired PDU session, the QFM Activation information is equivalent to an application first switch indication. When the AF-triggered Candidate QFM Activation information comprises the indication to switch from parallel (or simultaneous) to duplicated (or redundant) usage of the paired PDU session, the AF-triggered Candidate QFM Activation information is equivalent to an application second switch information.

Another alternative to implementing step 1b2 is via direct interaction between SMF and AF. This could be realized by AF exposing an event called “AF-triggered QFM Capability” and SMF subscribing to such event for the Paired PDU sessions with QFm Capability. The subscription input parameters may comprise one or more of the following parameters:
Transaction Reference ID,
Application information (e.g., Application ID, External Application Identifier),
Data Network information (e.g., DNN, and/or DNAI),
UE information (e.g., IP address or MAC address or SUPI),
One or more flow descriptions (e.g. source IP address, destination IP address, port numbers, the protocol information),
Identification of the application session context,
Paired PDU session Identification,
One or more PDU session Identification, and
One or more Network Slices (e.g., S-NSSAI).

The notification message received by SMF is the AF-triggered Candidate QFM Activation information, and the parameters in this message may comprise:
Subscription correlation identification (which relates the notification message to the parameters requested in the subscription input), and/or
A flag indicating that the QFM capability activation of the switch from duplicated to parallel usage of the paired PDU sessions should be started for the Paired PDU session related to the parameters included in the subscription input parameters.

If the AF is capable, it is also possible that the AF-triggered Candidate QFM Activation information may comprise the information related to the QFM Information, for instance, with a candidate QFM information, where the AF sends this candidate QFM Information so that SMF uses the Candidate QFM information from the AF as input for the determination of the QFM Activation Information.

When the AF-triggered Candidate QFM Activation information comprises the indication to switch from duplicated (or redundant) to parallel usage of the paired PDU session and the AF is capable of providing the candidate QFM information, the candidate QFM Information is equivalent to an application candidate first switch indication. When the AF-triggered Candidate QFM Activation information comprises the indication to switch from parallel (or simultaneous) usage to duplicated (or redundant) of the paired PDU session and the AF is capable of providing the candidate QFM information, the candidate QFM Information is equivalent to an application candidate second switch indication.

When the SMF is aware that QFM Capability should be activated, the SMF determines the QFM Activation Information, for instance, deciding (or selecting) the native flows and visiting flows that will be switched from duplicated transmission of data traffic to the parallel usage of the resources associated with the visiting flows for the data transmission of data traffic of the application without duplication of packets (as in Step 2 of FIG. 7). The SMF determines the values for the QFM Activation information parameters (or fields) as defined before.

It is possible that the SMF provides one or two QFM Activation information to each UE and/or UPF. This can happen if the QFM capability should be activated for the UL traffic and/or DL traffic. Or, it is also possible that the SMF includes the same QFM Activation information to each UE and/or UFP the relevant information for the QFM capability activation for both the UL and DL in the same QFM Activation information message.

The QFM Activation Information (one or more) is prepared by SMF and is provided to UPF via N4 Session Update (as in Step 3a of FIG. 7), while the QFM Activation prepared by SMF is provided to UE via the extensions on the N2 SM information (as in Step 3b of FIG. 7).

The AF is notified by SMF in Step 4 of FIG. 7, which may be based on the mechanisms described in steps 303 and 306. The SMF this time informs the AF that a QFM Capability has been activated. Additionally, the SMF can also notify the AF that the requested AF-triggered Candidate QFM Activation information has been accepted (without any changes); or has been rejected; or has been modified in order to enable the activation of the QFM Capability.

After Step 3 of FIG. 7 is executed, the changes in the QFM information are enforced in the UE and UPF based on the QFM Activation information received directly or indirectly (via AMF, N2 SM information) from SMF. The effect is the parallel usage of the resources from the Paired PDU session, according to the QFM Activation Information.

The SMF (in option 310) or AF (in option 330) is adapted to keep monitoring the QFM Conditions and/or further application level information to determine when the QFM Capability should be deactivated (as in Step 5 of FIG. 7). When the conditions are reached, the SMF determines again the QFM Activation information this time to switch from parallel to duplicated use of the resources from the paired PDU sessions. Steps 6 and 7 of FIG. 7 are for the deactivation of the QFM capability and informing the AF about the deactivation of the QFM Capability. FIGS. 6 and 7 may be implemented in a similar way as steps 3 and 4 of FIG. 7.

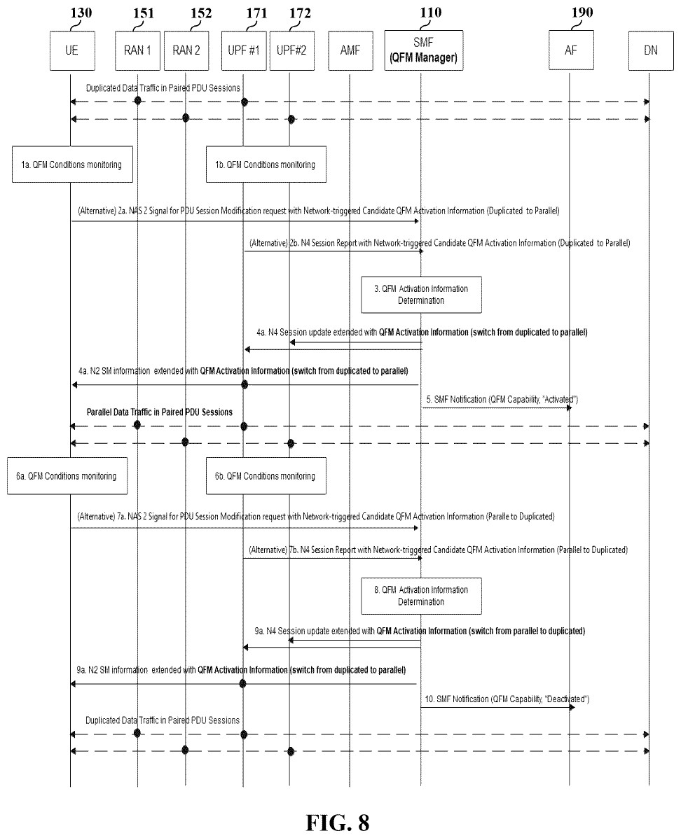

FIG. 8 shows an example of signaling of SM Entity Triggered QFM Capability (option 320). Features of FIG. 8 may be applicable to FIGS. 1-6. In this case, UE and UPF, as examples of SM entity, are adapted to trigger/activate the QFM Capability. The UE and UPF may receive QFM Conditions in advance.

Based on the received QFM Conditions, UE and UPF (Step 1 of FIG. 8) start monitoring the QFM conditions. It is possible that UE and/or UPF identify that the QFM conditions to activate the QFM capability are reached (Steps 2a or 2b of FIG. 8). In fact steps 2a and 2b of FIG. 8 may happen simultaneously, or only one of them may be executed.

Optionally, the UE may be able to detect the conditions to activate the QFM Capability for the UL traffic, i.e., from UE to DN. The UPF may be more capable of identifying the conditions to trigger the QFM Capability activation due to issues in the DL traffic from DN to UE.

The UE and/or UPF provide the SMF with the Network-triggered Candidate QFM Activation information. In the case of the UE, this information can be provided to SMF either via N2 SM information where UE requests the PDU session modification and includes the Network-triggered Candidate QFM Activation information. In the case of the UPF the Network-triggered Candidate QFM Activation information may be included as a report to be sent from the UPF to the SMF. Or, there may be a service exposed by the UPF so that the SMF can invoke such service to request and retrieve the information, or it is also possible that the SMF subscribes to such a service to be notified about the Network-triggered Candidate QFM Activation information.

When the Network-triggered Candidate QFM Activation information comprises the indication to switch from duplicated (or redundant) to parallel usage of the paired PDU session, the Network-triggered Candidate QFM Activation information is equivalent to a network first switch indication. When the Network-triggered Candidate QFM Activation information comprises the indication to switch from parallel (or simultaneous) to duplicated (or redundant) usage of the paired PDU session, the Network-triggered Candidate QFM Activation information is equivalent to a network second switch information.

The Network-triggered Candidate QFM Activation information may comprise one or more of the following:
UE identification (SUPI, or IP address),
PDU session paired ID,
One or more PDU session identification,
Proposal of (or a candidate) QFM Activation information which is a proposal of the configuration of the resources (e.g., QoS flows, or flows) of the paired PDU sessions for switching from duplicated usage of the resources into parallel usage of the resources. In other words, the proposal QFM activation information comprises the relevant information (e.g., such as QFM Tunnel information among others related to QFM Information) or a candidate QFM Information for the activation or deactivation of the QFM capability,
A flag indicating that the QFM capability activation of the switch from duplicated to parallel usage of the paired PDU sessions should be started, and
A flag indicating that the QFM capability should be deactivated (i.e., a switch from parallel usage of the resources of the paired PDU sessions into duplicated usage of the resources of the paired PDU sessions).

When the Network-triggered Candidate QFM Activation information comprises the indication to switch from duplicated (or redundant) to parallel usage of the paired PDU session and a candidate QFM information, the candidate QFM Information comprised in Network-triggered Candidate QFM Activation information is equivalent to a network candidate first switch indication. When the Network-triggered Candidate QFM Activation information comprises the indication to switch from parallel (or simultaneous) usage to duplicated (or redundant) of the paired PDU session and the candidate QFM information, the candidate QFM Information is equivalent to a network candidate second switch indication.

SMF receives the Network-triggered Candidate QFM Activation information from UE and/or UPF. If there is a proposal (or candidate) QFM Activation, SMF evaluates if the proposed changes in the usage of the resources of the paired PDU sessions to switch from duplicated to parallel usage of the paired PDU sessions is appropriate. If no candidate QFM Activation information, the SMF itself determines the QFM activation information.

In Steps 4a and 4b of FIG. 8, SMF provides the UE and/or the UPF with the determined QFM Activation Information. The implementation of how this information is sent to the UE and UPF may follow the same approach described in Step 3 of FIG. 7. The SMF notifies the AF about the activation of the QFM Capability using the same implementation options presented in steps 303 and 306.

UE and/or UPF enforce the changes in the QFM Information they control based on the received QFm Activation Information from SMF (directly or indirectly), and start to monitor the QFM conditions to determine when to stop the parallel usage of the resources of the paired PDU sessions and switch back to the duplicated usage of the resources of the paired PDU sessions (Step 6 of FIG. 8). When the QFM conditions are met, UE and/or UPF send to SMF another Network-triggered Candidate QFM Activation information with the indications to stop switch from parallel to duplicated usage of the paired PDU sessions (i.e., deactivate the QFM capability) as illustrated in Step 7 of FIG. 8.

SMF executes in step 8 and 9 of FIG. 8 in a similar of executing steps 3 and 4 of FIG. 8. The difference is that all the information sent to the UE and/or UPF is to deactivate the QFM Capability, and notify the AF about the deactivation using the same implementation mechanism descreibed in steps 303 and 306.

It is also possible that the QFM Activation information further includes a temporal indication denoting the interval of time that the QFM migration should be activated. For instance, this temporal indication can be implemented as a definition of a start and end period; or it could be implemented as a number (or a delay or a timer), that indicates that after such given number or delay or timer is passed the QFM migration should be automatically deactivated. In this case, UPF and/or UE would provide to the SMF a QFM Activation information in step 7a of FIG. 8 comprising an indication that the timer (or temporal indication) to deactivate the QFM migration has been reached. In this case, depending on different implementations, UPF and/or UE could automatically revert to the use of the original QFM information without the need to receive further QFM Activation information in steps 9a and 9b of FIG. 8. The deactivation would be in this case automatic.

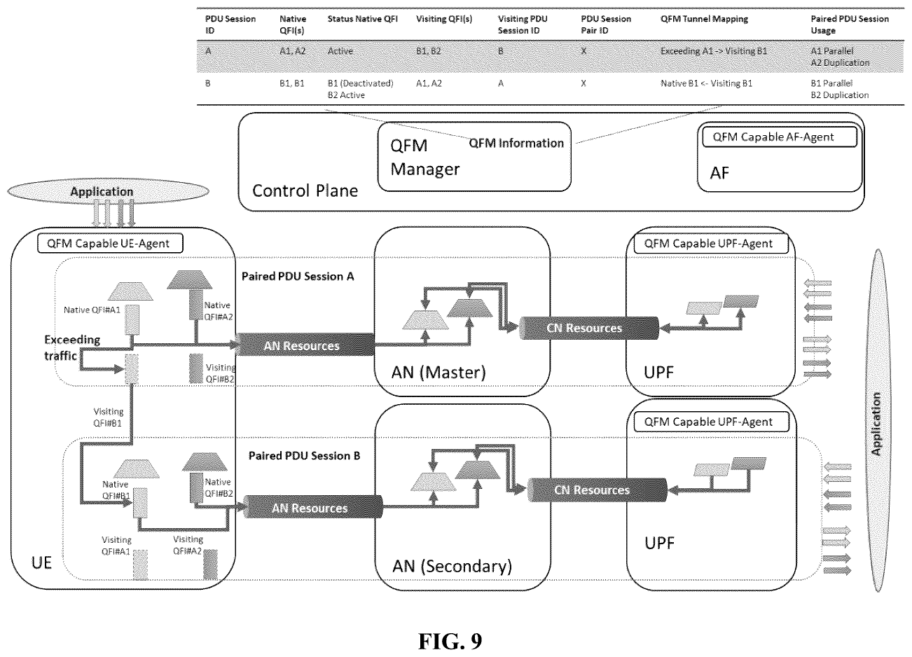

FIG. 9 illustrates an example of the activation of QFM capability for exceeding traffic of a flow in a paired PDU session. In this example, for PDU session A, a visiting QFI #B1 is used to transmit the exceeding traffic of QFI A #1 of PDU session A. For PDU session A, QFI #B1 is visiting since QFI #B1 is associated with PDU session B. Similarly, for PDU session B, QFI #A1 is visiting. The native and visiting flow abstraction enables a link between mapped flows in paired PDU sessions.

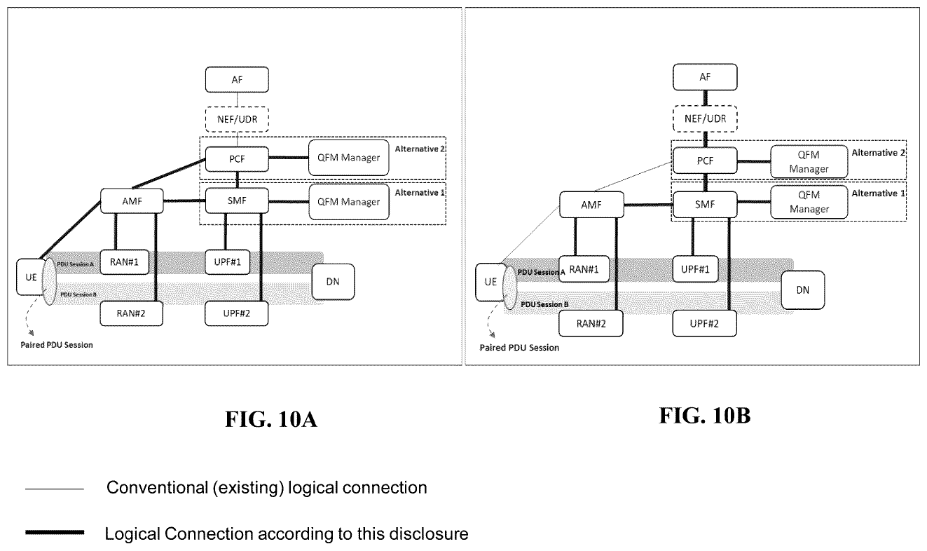

FIG. 10A-B illustrates examples of architectures according to this disclosure.

FIG. 10A shows an architecture aligned with 3GPP 5G principles from Prose and ATSSS traffic offloading. This architecture may be complex but potentially faster. The QFM Manager is implemented either in SMF or PCF. The identification of the QFM Capability can be performed either via subscription information or via QFM Policy delivery and UE Policy Association. Triggering flow migration via UE and/or UPF (Option 320) is the fast way to activate the QFM capability. Nevertheless, the triggering of QFM capability via the QFM Manager itself (Option 310) is also allowed.

FIG. 10B shows an architecture aligned with 3GPP 5G principles for AF influencing QoS and Redundant Transmission with DC. This architecture may be simple but potentially slower. The QFM Manager is implemented in SMF or PCF. The QFM Capability is identified via AF information.

In FIG. 10A and FIG. 10B, When the QFM Manager is implemented as part of the PCF NF, the procedures and the services related to the SM Policy Association are extended in order to allow PCF to provide to SMF information related to any of the following information: QFM Capability Indication, QFM Information, QFM Policy and QFM Subscription Information, QFM Conditions, QFM Activation Information (which is later forward via SMF to the SM entities). Additionally, PCF may also be able to obtain AF-triggered QFM Activation information from the AF, provide to the AF with the QFM status indications, and obtain Network-triggered QFM Activation information from UPF and/or UE using the SMF as an intermediary entity that provides or forwards this information to PCF via SM policy related procedures.

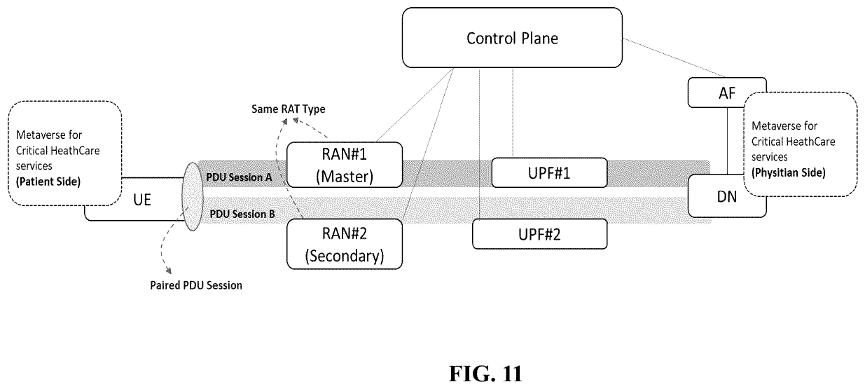

FIG. 11 shows an application scenario of this disclosure. This disclosure may be applicable to 5G networks as defined by 3GPP in 3GPP TS 23.501. For simplification, FIG. 11 abstracts specific CP functions used in the scenario. Generally, AMF, SMF, PCF, UDR, UDM are examples of CP NFs. FIG. 11 also illustrates Dual Connectivity (DC) with Redundant Transmission applied to Metaverse Critical HeathCase application. The two PDU sessions illustrated in FIG. 11 are paired and one of the PDU sessions is used for the duplication of the data traffic from the UE to the DN to provide a certain level the reliability of the data transmission. The paired PDU session are using the same type of Radio Access Technology (i.e., single or equal RAT for both PDU sessions) within the same mobile network (e.g., single PLMN). In case there is more data traffic which one single PDU session A cannot fulfill, according to this disclosure, QFM capability can be activated for PDU session B, which is similar to FIG. 9.

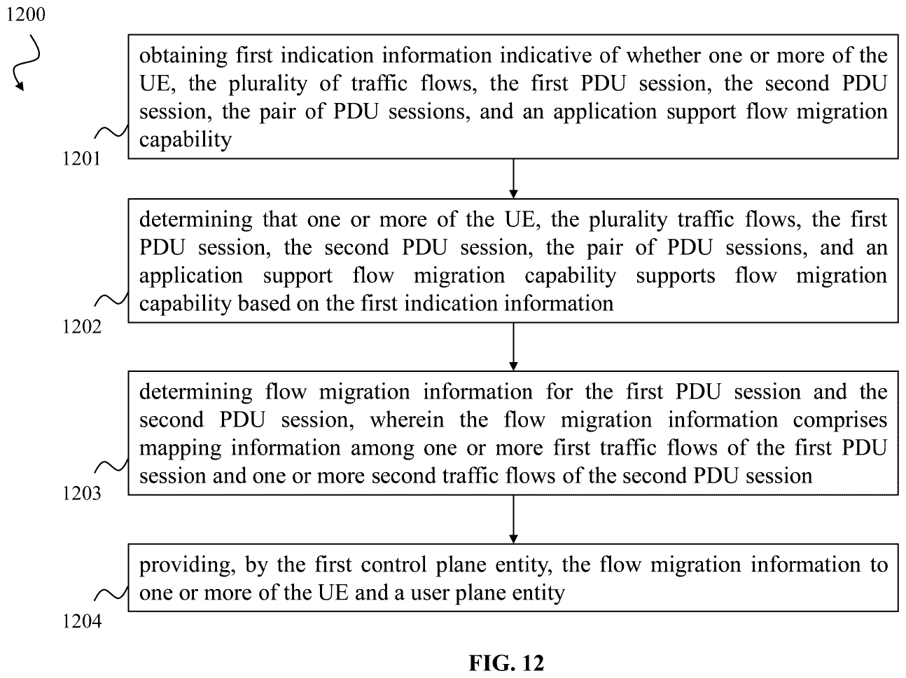

FIG. 12 shows a method 1200 according to this disclosure. The method 1200 is for managing data traffic transmission of a plurality of traffic flows of UE. The plurality of traffic flows of the UE are associated with a pair of PDU sessions of the UE. A first PDU session of the pair of PDU sessions is connectable to a data network using a first access network; a second PDU session of the pair of PDU sessions is connectable to the data network using a second access network. The first access network and the second access network are of the same type of radio access technology.

The method 1200 is performed by a first control plane entity 110 and comprises the following steps:
step 1201: obtaining, by the first control plane entity, first indication information, wherein the first indication information is indicative of whether one or more of the UE, the plurality of traffic flows, the first PDU session, the second PDU session, the pair of PDU sessions, and an application support flow migration capability;
step 1202: determining, by the first control plane entity, that one or more of the UE, the plurality traffic flows, the first PDU session, the second PDU session, the pair of PDU sessions, and an application support flow migration capability supports flow migration capability based on the first indication information;
step 1203: determining, by the first control plane entity, flow migration information for the first PDU session and the second PDU session, wherein the flow migration information comprises mapping information among one or more first traffic flows of the first PDU session and one or more second traffic flows of the second PDU session; and
step 1204: providing, by the first control plane entity, the flow migration information to one or more of the UE and a user plane entity.

The flow migration capability indicates a capability of switching the data traffic transmission between redundant transmission and parallel transmission.

For redundant transmission, data packets related to one or more first traffic flows from the plurality of traffic flows are duplicated in one or more second traffic flows from the plurality of flows, in which the one or more first traffic flows are related to the first PDU session, and the one or more second traffic flows are related to the second PDU session.

For parallel transmission, the data packets related to the one or more first traffic flows are transmitted either:
in both of the first and second traffic flows, wherein the data packets exceeding the capacity of the one or more first traffic flows are transmitted in the one or more second traffic flows, or
only in the one or more second traffic flows, wherein all data packets related to the one or more first traffic flows are transmitted in the one or more second traffic flows.

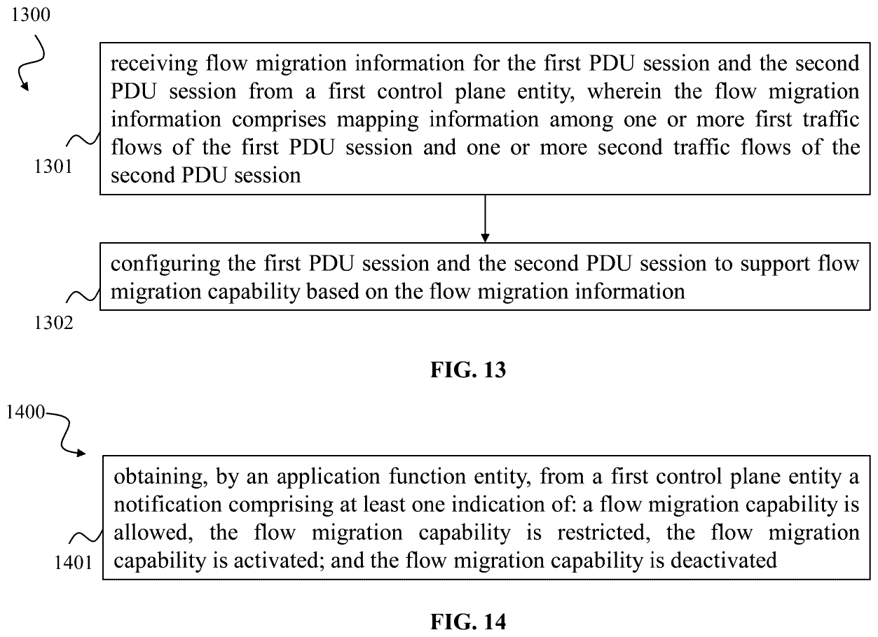

FIG. 13 shows a method 1300 according to this disclosure. The method 1300 is for managing data traffic transmission of a plurality of traffic flows of UE. The plurality of traffic flows of the UE are associated with a pair of PDU sessions of the UE. A first PDU session of the pair of PDU sessions is connectable to a data network using a first access network; a second PDU session of the pair of PDU sessions is connectable to the data network using a second access network. The first access network and the second access network are of the same type of radio access technology.

The method 1300 is performed by a user plane flow migration entity 130, 171, 172 and comprises the following steps:
step 1301: receiving, by the user plane flow migration entity, flow migration information for the first PDU session and the second PDU session from a first control plane entity, wherein the flow migration information comprises mapping information among one or more first traffic flows of the first PDU session and one or more second traffic flows of the second PDU session; and
step 1302: configuring, by the user plane flow migration entity, the first PDU session and the second PDU session to support flow migration capability based on the flow migration information.

FIG. 14 shows a method 1400 according to this disclosure. The method 1400 is for managing data traffic transmission of a plurality of traffic flows of UE. The plurality of traffic flows of the UE are associated with a pair of PDU sessions of the UE. A first PDU session of the pair of PDU sessions is connectable to a data network using a first access network; a second PDU session of the pair of PDU sessions is connectable to the data network using a second access network. The first access network and the second access network are of the same type of radio access technology.

The method 1400 is performed by an application function entity 190 and comprises:
step 1401: obtaining, by the application function entity, from a first control plane entity a notification comprising at least one indication of: a flow migration capability is allowed, the flow migration capability is restricted, the flow migration capability is activated; and the flow migration capability is deactivated, wherein the flow migration capability indicates a capability of switching the data traffic transmission between redundant transmission and parallel transmission.

The methods of FIGS. 12-14 may share the same or corresponding features disclosed with respect to FIGS. 1-11, which are not repeated herein.

This disclosure, for example, provides a QFM Capability Indication that can be implemented as: QFM Subscription Information, QFM AF Indication, or QFM Policy Indication. This disclosure, for example, also provides QFM Information with the QFM Tunnel mapping information. The QFM information may be indicative of native and visiting flows logical definition for each paired PDU session. This disclosure, for example, also provides:
QFM Indication that supports the QFM manager to trigger the checks to obtain the QFM Capability Indication;
QFM Conditions that allow the QFM Manager or the SM Entities to trigger the activation or deactivation of the QFM Capability; and
notifications provided by the QFM Manager to AF about the status of the QFM Capability for a given UE.

The tunnel mapping information may be also referred to as QFM Tunnel Mapping.

In this way, network operators may have the capability to alleviate the shortage of resources because of the sudden extra capacity required by the XR application, while the network activates further mechanisms to change configurations for UEs at the affected region.

The disclosure, for example, also provides an indication for the activation or deactivation of QFM Capability, which may be implemented as:
local policies;
Network-triggered Candidate QFM Activation Information;
AF-triggered Candidate QFM Activation Information.

This disclosure, for example, also provides QFM Activation Information for switching between redundant transmission and parallel transmission, and QFM Policy determining the conditions for activation or deactivation of QFM Capability for paired PDU sessions.

In this way, the package dropping of flows from XR UEs that suddenly need extra capacity can be eliminated or reduced, since two paired paths are used in an effective way.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A first control plane entity for managing data traffic transmission of a plurality of traffic flows of user equipment (UE), wherein the plurality of traffic flows of the UE are associated with a pair of packet data network (PDU) sessions of the UE, wherein a first PDU session of the pair of PDU sessions is connectable to a data network using a first access network, and a second PDU session of the pair of PDU sessions is connectable to the data network using a second access network, wherein the first access network and the second access network are of a same type of radio access technology, and the first control plane entity comprises:
a processor, and
a memory coupled to the processor and storing processor-executable instructions, which upon being executed by the processor, facilitates the first control plane entity to:
obtain first indication information, wherein the first indication information is indicative of whether one or more of the UE, the plurality of traffic flows, the first PDU session, the second PDU session, the pair of PDU sessions, and an application support flow migration capability,
wherein the flow migration capability indicates a capability of switching the data traffic transmission between redundant transmission and parallel transmission,
wherein for redundant transmission, data packets related to one or more first traffic flows from the plurality of traffic flows are duplicated in one or more second traffic flows from the plurality of flows, wherein the one or more first traffic flows are related to the first PDU session, and the one or more second traffic flows are related to the second PDU session, and
for parallel transmission, the data packets related to the one or more first traffic flows are transmitted either in both of the first and second traffic flows, wherein the data packets exceeding the capacity of the one or more first traffic flows are transmitted in the one or more second traffic flows, or only in the one or more second traffic flows, wherein all data packets related to the one or more first traffic flows are transmitted in the one or more second traffic flows;
determine that one or more of the UE, the plurality traffic flows, the first PDU session, the second PDU session, the pair of PDU sessions, and the application support flow migration capability based on the first indication information;
determine flow migration information for the first PDU session and the second PDU session, wherein the flow migration information comprises mapping information among the one or more first traffic flows of the first PDU session (and the one or more second traffic flows of the second PDU session; and
provide the flow migration information to one or more of the UE and a user plane entity.

2. The first control plane entity according to claim 1, wherein the processor is configured to further execute the instructions which facilitates the first control plane entity to:
provide first switch information to one or more of the user plane entity and the UE, wherein the first switch information comprises information to enable the parallel transmission between the one or more first traffic flows and the one or more second traffic flows.

3. The first control plane entity according to claim 1, wherein the processor is configured to further execute the instructions which facilitates the first control plane entity to:
provide second switch information to one or more of the user plane entity and the UE, wherein the second switch information comprises information to enable the redundant transmission between the one or more first traffic flows and the one or more second traffic flows.

4. The first control plane entity according to claim 1, wherein the first indication information comprises one or more of the following:
a flow migration subscription indication;
a flow migration application function indication; and
a flow migration policy indication.

5. The first control plane entity according to claim 4, wherein the flow migration subscription indication is obtained from a further entity storing subscription information and the flow migration subscription indication, and the flow migration subscription indication is indicative of allowing or restricting the flow migration capability for one or more of the following information:
UE identification;
application information;
data network information;
network slice information;
public land mobile network (PLMN) identification;
PDU session identification;
PDU session pair identification;
flow description; and
flow identification.

6. The first control plane entity according to claim 4, wherein the flow migration application function indication is obtained from an application function entity, and the flow migration application function indication is indicative of allowing or restricting the flow migration capability for one or more of the following information:
UE identification;
application information;
data network information;
PDU session identification;
PDU session pair identification;
transaction reference ID;
application session context identification;
application session identification;
flow description; and
network slice information.

7. The first control plane entity according to claim 4, wherein the flow migration policy indication is obtained from a second control plane entity or is configured at the first control plane entity, and the flow migration policy indication is indicative of allowing or restricting the flow migration capability for one or more of the following information:
UE identification;
application information;
data network information; and
network slice information.

8. The first control plane entity according to claim 4, further configured to obtain flow migration condition information, wherein the flow migration condition information comprises monitoring information for activating or deactivation the flow migration capability.

9. The first control plane entity according to claim 8, wherein the flow migration condition information is obtained based on one or more of the following:
together with the flow migration subscription indication;
together with the flow migration application function indication;
together with the flow migration policy indication;
is configured at the first control plane entity; and
is comprised in the flow migration information.

10. The first control plane entity according to claim 8, wherein the flow migration condition information comprises one or more of:
an upper threshold of a QoS-related measurement to activate the flow migration capability;
a lower threshold of a QoS-related measurement to deactivate the flow migration capability;
a maximum interval of time for keeping the flow migration capability activated;
a minimum interval of time for keeping the flow migration capability activated;
a threshold to deactivate the flow migration capability; and
a degradation threshold to deactivate the flow migration capability.

11. The first control plane entity according to claim 1, wherein the processor is configured to further execute the instructions which facilitates the first control plane entity to:
obtain a flow migration trigger indication, wherein the flow migration trigger indication is a flag that indicates to the first control plane entity that the establishment of the first PDU session and/or the second PDU session requires the flow migration capability.

12. The first control plane entity according to claim 11, wherein the processor is configured to further execute the instructions which facilitates the first control plane entity to:
obtain the first indication information based on the flow migration trigger indication.

13. The first control plane entity according to claim 1, wherein the mapping information comprises information related to mapping the one or more first traffic flows associated with the first PDU session to the one or more second flows associated with the second PDU session, wherein the first PDU session and the second PDU session are associated with a same PDU session pair ID.

14. The first control plane entity according to claim 13, wherein the mapping information further comprises one or more of the following:
tunnel mapping information for mapping a core network tunnel and/or a radio access network tunnel of the one or more first traffic flow associated with the first PDU session to one or more further core network tunnels and/or one or more further radio access network tunnels of the one or more second traffic flows associated with the second PDU session; and
a type of data traffic migration, wherein the type of data traffic migration defines the mapping of data traffic being migrated from the one or more first traffic flows into the one or more second traffic flows.

15. The first control plane entity according to claim 14, wherein the type of data traffic migration is indicative of one of the following types:
rerouting all data transmission from the one or more first traffic flows to the one or more second traffic flows,
rerouting data transmission exceeding a certain bit rate from the one or more first traffic flows to the one or more second traffic flows, and
rerouting a certain percentage of data transmission from the one or more first traffic flows to the one or more second traffic flows.

16. The first control plane entity according to claim 1, wherein the processor is configured to further execute the instructions which facilitates the first control plane entity to:
send a notification to the application function entity,
wherein the notification is indicative of one or more of the following:
the flow migration capability is allowed;
the flow migration capability is restricted;
the flow migration capability is activated; and
the flow migration capability is deactivated.

17. The first control plane entity according to claim 1, wherein the first control plane entity is further configured to obtain one or more of:
a network first switch indication from the user plane function and/or from the UE, wherein the network first switch indication is indicative of a need or a request for activating the flow migration capability;
an application first switch indication from an application function entity, wherein the application first switch indication is indicative of a need or a request for activating the flow migration capability.

18. The first control plane entity according to claim 1, wherein the first control plane entity is further configured to determine the first switch information based on the network first switch indication, or the application first switch indication, or an internal configuration related to the first switch information, or a combination thereof.

19. A method for managing data traffic transmission of a plurality of traffic flows of user equipment (UE), wherein the plurality of traffic flows of the UE are associated with a pair of packet data network (PDU) sessions of the UE, wherein a first PDU session of the pair of PDU sessions is connectable to a data network using a first access network, and a second PDU session of the pair of PDU sessions is connectable to the data network using a second access network, wherein the first access network and the second access network are of a same type of radio access technology, and the method comprises:
obtaining, by a first control plane entity, first indication information, wherein the first indication information is indicative of whether one or more of the UE, the plurality of traffic flows, the first PDU session, the second PDU session, the pair of PDU sessions, and an application support flow migration capability,
wherein the flow migration capability indicates a capability of switching the data traffic transmission between redundant transmission and parallel transmission,
wherein for redundant transmission, data packets related to one or more first traffic flows from the plurality of traffic flows are duplicated in one or more second traffic flows from the plurality of flows, wherein the one or more first traffic flows are related to the first PDU session, and the one or more second traffic flows are related to the second PDU session, and
for parallel transmission, the data packets related to the one or more first traffic flows are transmitted either in both of the first and second traffic flows, wherein the data packets exceeding the capacity of the one or more first traffic flows are transmitted in the one or more second traffic flows, or only in the one or more second traffic flows, wherein all data packets related to the one or more first traffic flows are transmitted in the one or more second traffic flows;
determining, by the first control plane entity, that one or more of the UE, the plurality traffic flows, the first PDU session, the second PDU session, the pair of PDU sessions, and the application support flow migration capability supports flow migration capability based on the first indication information;
determining, by the first control plane entity, flow migration information for the first PDU session and the second PDU session, wherein the flow migration information comprises mapping information among one or more first traffic flows of the first PDU session and one or more second traffic flows of the second PDU session; and
providing, by the first control plane entity, the flow migration information to one or more of the UE and a user plane entity.

20. A non-transitory computer-readable medium comprising instructions which, upon being executed by a computer, cause the computer to perform the method according to claim 19.
